(19) United States
(12) Patent Application Publication
(10) Pub. No.: US 2021/0122367 A1
(43) Pub. Date: Apr. 29, 2021

(54) METHODS, DEVICES, MEDIA, AND APPARATUSES OF DETECTING MOVING OBJECT, AND OF INTELLIGENT DRIVING CONTROL

(71) Applicant: Beijing Sensetime Technology Development Co., Ltd., Beijing (CN)

(72) Inventors: Xinghua YAO, Beijing (CN); Runtao LIU, Beijing (CN); Xingyu ZENG, Beijing (CN)

(21) Appl. No.: 17/139,492

(22) Filed: Dec. 31, 2020

Related U.S. Application Data
(63) Continuation of application No. PCT/CN2019/114611, filed on Oct. 31, 2019.

(30) Foreign Application Priority Data
May 29, 2019 (CN) 201910459420.9

(51) Int. Cl. B60W 30/09; G06T 7/215; G06T 7/285; G06T 7/593; G06K 9/62; G06K 9/20; G06T 7/246; G06K 9/00; B60W 30/095

(52) U.S. Cl. CPC B60W 30/09; G06T 7/215; G06T 7/285; G06T 7/593; G06K 9/6218; G06K 9/2054; B60W 2420/42; G06K 9/00805; B60W 30/0956; G06T 2207/20084; G06T 2207/20081; G06T 2207/10021; G06T 2207/30261; G06T 7/248

(57) ABSTRACT

A method of detecting moving object, comprises: acquiring depth information of pixels of an image to be processed; acquiring optical flow information between the image to be processed and a reference image, wherein the reference image and the image to be processed are two images that are collected by an image pickup device in a continuous photographing mode and have timing a sequence relationship; acquiring, according to both the depth information and the optical flow information, a three-dimensional motion field of the pixels of the image to be processed with respect to the reference image; and determining a moving object involved in the image to be processed according to the three-dimensional motion field. An electronic apparatus is further provided.

### CROSS REFERENCE TO RELATED APPLICATIONS

This application is a continuation application of International Patent Application No. PCT/CN2019/114611 filed with the China National Intellectual Property Administration (CNIPA) on Oct. 31, 2019, which is based on and claims the priority to and benefits of Chinese Patent Application No. 201910459420.9, entitled “METHODS, DEVICES, MEDIA, AND APPARATUSES OF DETECTING MOVING OBJECT, AND OF INTELLIGENT DRIVING CONTROL” and filed with the CNIPA on May 29, 2019. The content of all of the above-identified applications is incorporated herein by reference in their entirety.

### TECHNICAL FIELD

The present disclosure relates to computer vision technology, and more particularly, to methods and devices of detecting moving object, methods and devices for intelligent driving control, and electronic apparatuses, computer-readable storage medium, and computer programs thereof.

### BACKGROUND

In technical fields such as intelligent driving and security monitoring, it is necessary to sense moving objects and their moving directions. Sensed moving objects and their moving directions may be provided to a decision-maker so that the decision-maker can make a decision based on the sensed results. For example, for an intelligent driving system in a case that a moving object (such as a person or an animal) at the side of the road is sensed as approaching the center of the road, the decision-maker can control a vehicle to slow down or even stop to ensure the safe driving of the vehicle.

### SUMMARY

Embodiments of the present disclosure provide a technical solution for detecting moving object.

According to a first aspect of the present disclosure, a method of detecting moving object is provided, the method includes: acquiring depth information of pixels of an image to be processed; acquiring optical flow information between the image to be processed and a reference image; wherein the reference image and the image to be processed are two images that are collected by an image pickup device in a continuous photographing mode and have a timing sequence relationship; acquiring a three-dimensional motion field of the pixels of the image to be processed with respect to the reference image according to both the depth information and the optical flow information; and determining a moving object involved in the image to be processed according to the three-dimensional motion field.

According to a second aspect of the present disclosure, there is provided a method of intelligent driving control, including: acquiring, by an image pickup device mounted on a vehicle, a video stream of a road where the vehicle is located; performing, through the method of detecting moving object, moving object detection on at least one video frame of the video stream to determine a moving object involved in the video frame; and generating and outputting a control instruction for the vehicle according to the moving object.

According to a third aspect of the present disclosure, a device for detecting moving object is provided, including: a first acquiring module, configured to acquire depth information of pixels of an image to be processed; a second acquiring module, configured to acquire optical flow information between the image to be processed and the reference image, wherein the reference image and the image to be processed are two images that are collected by an image pickup device in a continuous photographing mode and have a timing sequence relationship; a third acquiring module, configured to acquire a three-dimensional motion field of pixels of the image to be processed with respect to the reference image according to both the depth information and the optical flow information; a moving object determining module, configured to determine a moving object involved in the image to be processed according to the three-dimensional motion field.

According to a fourth aspect of the present disclosure, there is provided a device for intelligent driving control, including: a fourth acquiring module, configured to acquire a video stream of a road where the vehicle is located by an image pickup device mounted on the vehicle; the above-mentioned device for detecting moving object, configured to perform moving object detection on at least one video frame of the video stream to determine a moving object involved in the video stream; and a control module, configured to generate and output a control instruction for the vehicle according to the moving object.

According to a fifth aspect of the present disclosure, there is provided an electronic apparatus, including: a processor, memory, a communication interface, and a communication bus, wherein the processor, the memory, the communication interface communicate each other through the communication bus. The memory is configured to store at least one executable instruction, the executable instruction causes the processor to execute the above method.

According to a sixth aspect of the present disclosure, there is provided a computer-readable storage medium having a computer program stored thereon, in a case that the computer program is executed by a processor, operations of the method according to any one of the embodiments of the present disclosure are implemented.

According to the seventh aspect of the present disclosure, there is provided a computer program, including computer instructions, which, in a case that the computer instructions is run in a processor of an apparatus, implements operations of the method according to any one of the embodiments of the present disclosure.

Based on the method of detecting moving object, the method of intelligent driving control, the device for detecting moving object, the device for intelligent driving control, and electronic apparatus, computer-readable storage medium, and computer program thereof provided by the present disclosure, a three-dimensional motion field of pixels of an image to be processed with respect to a reference can be determined according to both the depth information of the pixels of the image to be processed and the optical flow information between the image to be processed and the reference image. As the three-dimensional motion field may reflect a moving object, the moving objected involved in the image to be processed may be determined according to the three-dimensional motion field. Thus, the technical solution according to the present disclosure helps to improve the accuracy of sensing moving object, which facilitates to improve the safety of intelligent vehicle driving.

The technical solutions according to the present disclosure will be further described in detail below through the drawings and embodiments.

### BRIEF DESCRIPTION OF THE DRAWINGS

The drawings constituting a part of the specification illustrate the embodiments of the present disclosure, and serve to explain the principle of the present disclosure along with the description.

With reference to the drawings, the present disclosure can be understood more clearly according to the following detailed description, in which:

FIG. 1 illustrates a flowchart of a method of detecting moving object according to an embodiment of the present disclosure;

FIG. 2 illustrates a schematic view of an image to be processed in the present disclosure;

FIG. 3 illustrates a schematic view of a first disparity map of the image to be processed illustrated in FIG. 2;

FIG. 4 illustrates a schematic view of the first disparity map of the image to be processed according to an embodiment of the present disclosure;

FIG. 5 illustrates a schematic view of a convolutional neural network according to an embodiment of the present disclosure;

FIG. 6 illustrates a schematic view of a first weight distribution map of the first disparity map according to an embodiment of the present disclosure;

FIG. 7 illustrates a schematic view of the first weight distribution map of the first disparity map according to another embodiment of the present disclosure;

FIG. 8 illustrates a schematic view of a second weight distribution map of the first disparity map according to an embodiment of the present disclosure;

FIG. 9 illustrates a schematic view of a third disparity map according to an embodiment of the present disclosure;

FIG. 10 illustrates a schematic view of a second weight distribution map of the third disparity map illustrated in FIG. 9;

FIG. 11 illustrates a schematic view of optimally adjusting the first disparity map of the image to be processed of the present disclosure;

FIG. 12 illustrates a schematic view of a three-dimensional coordinate system according to an embodiment of the present disclosure;

FIG. 13 illustrates a schematic view of a reference image and an image after Warp processing according to an embodiment of the present disclosure;

FIG. 14 illustrates a schematic view of an image after Warp processing, an image to be processed and an optical flow map of the image to be processed with respect to the reference image according to an embodiment of the present disclosure;

FIG. 15 illustrates a schematic view of an image to be processed and its motion mask according to an embodiment of the present disclosure;

FIG. 16 illustrates a schematic view of a bounding box of moving object according to an embodiment of the present disclosure;

FIG. 17 illustrates a flowchart of a method of training a convolutional neural network according to an embodiment of the present disclosure;

FIG. 18 illustrates a flowchart of a method of intelligent driving control according to an embodiment of the present disclosure;

FIG. 19 illustrates a schematic structural view of a device for detecting moving object according to an embodiment of the present disclosure;

FIG. 20 illustrates a schematic structural view of a device for intelligent driving control according to an embodiment of the present disclosure; and

FIG. 21 illustrates a block diagram of an apparatus according to an exemplary embodiment of the present disclosure.

### DETAILED DESCRIPTION OF THE EMBODIMENTS

Various exemplary embodiments of the present disclosure will be described in detail with reference to the accompanying drawings. It should be noted that unless specifically stated otherwise, the relative arrangement of components and steps, numerical expressions and numerical values set forth in these embodiments cannot be construed as a limit to the scope of the present disclosure.

And meanwhile, it should be understood that, for ease of description, the various components illustrated in the drawings are not drawn in scale. The following description of at least one exemplary embodiment is actually only illustrative, and in no way serves as any limitation to the present disclosure and its application or use. The techniques, methods, and equipment known to one of ordinary skill in the relevant arts may not be discussed in detail, but where appropriate, the techniques, methods, and equipment should be regarded as a part of the specification. It should be noted that similar reference numerals and letters designate similar items in the following drawings, and therefore, once an item is defined in one drawing, it does not need to be discussed further in subsequent drawings.

Embodiments of the present disclosure may be applied to electronic apparatuses such as terminal devices, computer systems, and servers, which may be operated with many other general-purpose or special-purpose computing system environments or configurations. Examples of well-known terminal devices, computing systems, environments, and/or configurations suitable for using with electronic devices such as terminal devices, computer systems, and servers, include but not limited to: personal computer systems, server computer systems, thin clients, thick clients, handheld or laptop devices, microprocessor-based systems, set-top boxes, programmable consumer electronics, network personal computers, small computer systems, large computer systems, and distributed cloud computing technology environments including any of the above systems, etc.

Electronic apparatuses such as terminal devices, computer systems, and servers may be described in the general context of computer system executable instructions (such as program modules) executed by the computer system. Typically, program modules may include routines, programs, object programs, components, logic, and data structures, etc., which perform specific tasks or implement specific abstract data types. The computer system/server may be implemented in a distributed cloud computing environment. In the distributed cloud computing environment, tasks are executed by remote processing equipment connected via a communication network. And in a distributed cloud computing environment, program modules may be located on a storage medium of a local or remote computing system including a storage device.

### EXEMPLARY EMBODIMENTS

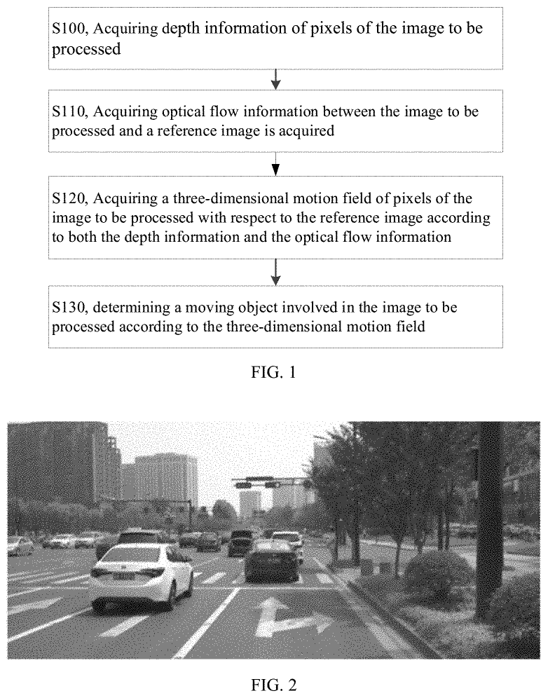

FIG. 1 illustrates a flowchart of a method of detecting moving object according to an embodiment of the present disclosure. As illustrated in FIG. 1, the method according to this embodiment includes: step S100, step S110, step S120, and step S130. The steps are described in detail hereinafter.

S100: Depth information of pixels of the image to be processed is acquired.

In an optional example of the present disclosure, depth information of the pixels (such as all the pixels) of the image to be processed may be acquired through a disparity map of the image to be processed. That is, the disparity map of the image to be processed is acquired first, and then, the depth information of the pixels of the image to be processed is acquired according to the disparity map of the image to be processed.

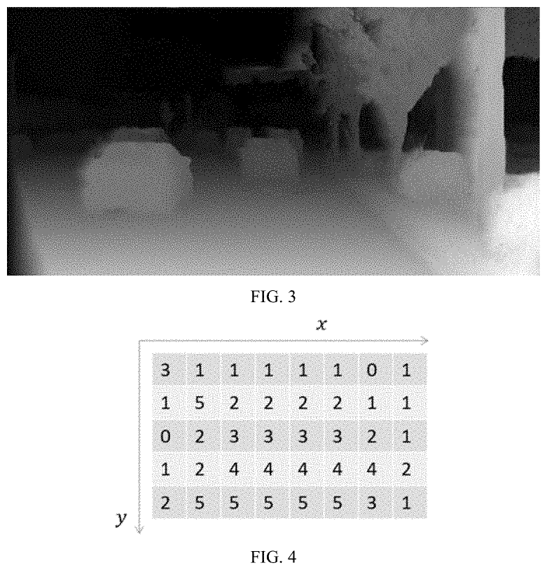

In an optional example of the present disclosure, for clarity of description, the disparity map of the image to be processed is referred to as a first disparity map of the image to be processed hereinafter. The first disparity map in the present disclosure is intended to describe a disparity of the image to be processed. The disparity may be referred to a difference between positions of a target object when being observed from two points apart from each other a certain distance. An example of the image to be processed is illustrated in FIG. 2. And FIG. 3 illustrates an example of the first disparity map of the image to be processed illustrated in FIG. 2. In an optional embodiment of the present disclosure, the first disparity map of the image to be processed in the present disclosure may further be expressed in a form as illustrated in FIG. 4. The numbers in FIG. 4 (such as 0, 1, 2, 3, 4, and 5, etc.) respectively represent: disparity of the pixels at the position (x, y) in the image to be processed. It should be particularly noted that no entire first disparity map is illustrated in FIG. 4.

In an optional example of the present disclosure, the image to be processed in the present disclosure is typically a monocular image. That is, the image to be processed is typically an image collected by a monocular image pickup device. In a case that the image to be processed is a monocular image, moving object detection can be achieved in the present disclosure without a binocular image pickup device, thereby reducing the cost of moving object detection.

In an optional example of the present disclosure, the first disparity map of the image to be processed may be acquired through a successfully pre-trained convolution neural network. For example, the image to be processed is input into a convolutional neural network for performing a disparity analysis by the convolution neural network, and a disparity analysis result is output from the convolutional neural network, such that the first disparity map of the image to be processed may be obtained on the basis of the disparity analysis result. The disparity map may be acquired through acquiring the first disparity map of the image to be processed by the convolution neural network, without calculating disparity between two images pixel-by-pixel and without calibrating the image pickup device. Thus, convenience and real-time performance of obtaining the disparity map is improved.

In an optional example of the present disclosure, the convolutional neural network typically includes but is not limited to: a plurality of convolutional layers (Cony) and a plurality of deconvolutional layers (Deconv). The convolutional neural network of the present disclosure may be divided into two parts, namely an encoding part and a decoding part. The image to be processed input into the convolutional neural network (the image to be processed as illustrated in FIG. 2) is encoded by the encoding part (i.e. feature extraction), and an encoding result of the encoding part is provided to the decoding part, such that the decoding part decodes the encoding result and outputs an decoding result. In the present disclosure, a first disparity map of the image to be processed (such as the disparity map illustrated in FIG. 3) may be acquired according to the decoding result output by the convolution neural network. In an optional embodiment of the present disclosure, the coding part of the convolutional neural network includes, but not limited to: a plurality of convolutional layers connected in sequence. The decoding part of the convolutional neural network includes, but not limited to: a plurality of convolutional layers and a plurality of deconvolutional layers, the plurality of convolutional layers and the plurality of deconvolutional layers are arranged alternately and connected in sequence.

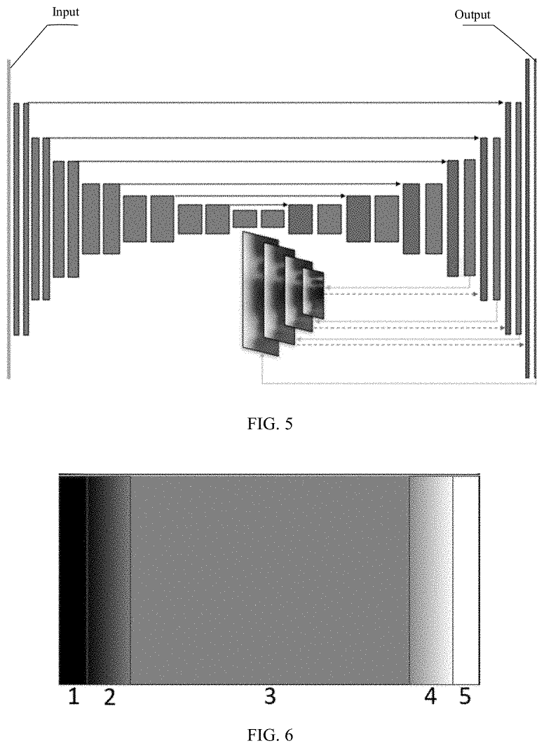

FIG. 5 illustrates an example of the convolutional neural network of the present disclosure. As illustrated in FIG. 5, the first rectangle on the left indicates an image to be processed input into the convolutional neural network, and the first rectangle on the right indicates a disparity map output by the convolutional neural network. Each rectangle among the second rectangle to the 15-th rectangle on the left indicates a convolution layer, all the rectangles from the 16-th rectangle on the left to the second rectangle on the right indicates convolution layers and deconvolution layers arranged alternately. For example, the 16-th rectangle on the left indicates a deconvolution layer, the 17-th rectangle on the left indicates a convolution layer, the 18-th rectangle on the left indicate a deconvolution layer, the 19-th rectangle on the left indicate a convolution layer, and so on, and it is also applied to the second rectangle on the right, and the second rectangle on the right indicates a deconvolution layer.

In an optional example of the present disclosure, low-level information and high-level information of the convolution neural network may be fused in a manner of skip connection. For example, output of at least one convolutional layer of the encoding part is provided to at least one deconvolutional layer of the decoding part through a skip connection. In an optional embodiment of the present disclosure, input of all convolutional layers of the convolutional neural network typically includes: output of the preceding layer (such as a convolutional layer or a deconvolutional layer), and input of at least one deconvolutional layer (such as part of the deconvolution layers or all the deconvolution layers) of the convolution neural network includes: upsample result of the output of the preceding convolution layer and output of a convolution layer of the coding part in skip connection with the deconvolution layer. For example, contents designated by a solid arrow drawn from the bottom of the convolutional layer on the right side of FIG. 5 represents output of the preceding convolutional layer, and a dashed arrow in FIG. 5 represents the upsample result provided to the deconvolutional layer, and a solid arrow drawn from the top of a convolutional layer on the left side of FIG. 5 represents output of a convolutional layer in skip connection with the deconvolutional layer. The number of skip connections and the network structure of the convolutional neural network are not limited in the present disclosure. In the present disclosure, the low-level information and the high-level information of the convolution neural network are fused to improve the accuracy of disparity map generated by the convolution neural network. In an optional embodiment of the present disclosure, the convolutional neural network of the present disclosure is trained with binocular image samples. For the training process of the convolutional neural network, please refer to the description in the following embodiments, and it is not elaborated here.

In an optional example of the present disclosure, the first disparity map of the image to be processed that is obtained through the convolution neural network may further be optimally adjusted, to make the first disparity map more accurate. In an optional embodiment of the present disclosure, the first disparity map of the image to be processed may be optimally adjusted by using a horizontal mirror image (for example, the left mirror image or the right mirror image) of the image to be processed. For ease of description, the horizontal mirror image of the image to be processed is referred to as a first horizontal mirror image, and a disparity map of the first horizontal mirror image is referred to as a second disparity map hereinafter. An example of optimally adjusting the first disparity map in the present disclosure is as follows:

Step A: a horizontal mirror image of the second disparity map is obtained.

In an optional embodiment of the present disclosure, the first horizontal mirror image is intended to indicate that the mirror image is a mirror image generated by performing a horizontal mirroring (rather than vertical mirroring) on the image to be processed. For ease of description, the horizontal mirror image of the second disparity map is referred to as a second horizontal mirror image hereinafter. In an optional embodiment of the present disclosure, the second horizontal mirror image in the present disclosure refers to a mirror image generated by performing a horizontal mirroring on the second disparity map. The second horizontal mirror image is still a disparity map.

In an optional embodiment of the present disclosure, left mirroring or right mirroring may be performed on the image to be processed first (as the left mirroring result is the same as the right mirroring result, it is possible to perform either of the left mirroring and the right mirroring on the image to be processed in the present disclosure), to obtain the first horizontal mirror image; and then, the disparity map of the first horizontal mirror image is acquired; and finally, left mirroring or right mirroring is performed on the second disparity map (as the left mirroring result of the second disparity map is same as the right mirroring result, it is possible to perform either of the left mirroring and the right mirroring on the second disparity map) to acquire a second horizontal mirror image. For convenience of description, the second horizontal mirror image is referred to as the third disparity map hereinafter.

As can be seen from the above description of the present disclosure, in the case of performing the horizontal mirroring on the image to be processed, it is possible to ignore whether the image to be processed is taken as a left-eye image or as a right-eye image. That is, in the present disclosure, regardless of whether the image to be processed is taken as a left-eye image or a right-eye image, either left mirroring or right mirroring may be performed on the image to be processed, thereby acquiring the first horizontal mirror image. Similarly, in the present disclosure, in the case of performing the horizontal mirroring on the second disparity map, it may by not considered whether the left mirroring or the right mirroring should be performed on the second disparity map.

It should be noted that, in the process of training the convolutional neural network which is configured to generate the first disparity map of the image to be processed, in a case that the left-eye image of the binocular image sample is provided as input to the convolutional neural network for training, the successfully trained convolutional neural network will take an input image to be processed as the left-eye image in testing and practical applications, that is, the image to be processed in the present disclosure is taken as the left-eye image to be processed. And in a case that the right-eye image of the binocular image sample is provided as input to the convolutional neural network for training, the successfully trained convolutional neural network will take the input image to be processed as the right-eye image in testing and practical applications, that is, the image to be processed in the present disclosure is taken as the right-eye image to be processed.

In an optional embodiment of the present disclosure, the aforementioned convolutional neural network may further be configured to acquire the second disparity map. For example, the first horizontal mirror image is input into the convolutional neural network for performing a disparity analysis by the convolution neural network, and the convolution neural network outputs disparity analysis result. Thus, in the present disclosure, a second disparity map may be acquired according to the output disparity analysis result.

Step B: Both a weight distribution map of the disparity map (that is, the first disparity map) of the image to be processed and a weight distribution map of the second horizontal mirror image (that is, the third disparity map) are acquired.

In an optional example of the present disclosure, the weight distribution map of the first disparity map is intended to describe respective weight value of a plurality of disparity values (for example, all disparity values) of the first disparity map. The weight distribution map of the first disparity map may include but is not limited to: a first weight distribution map of the first disparity map and a second weight distribution map of the first disparity map.

In an optional embodiment of the present disclosure, the first weight distribution map of the first disparity map is a weight distribution map set uniformly for the first disparity maps of a plurality of different images to be processed, i.e., the first weight distribution map of the first disparity map may be oriented to the first disparity maps of the plurality of different images to be processed, that is, the first disparity maps of the plurality of different images to be processed adopt the same first weight distribution map. Therefore, in the present disclosure, the first weight distribution map of the first disparity map may be referred to as a global weight distribution map of the first disparity map. The global weight distribution map of the first disparity map is intended to describe respective global weight values of a plurality of disparity values (such as all the disparity values) of the first disparity map.

In an optional embodiment of the present disclosure, the second weight distribution map of the first disparity map is a weight distribution map set for the first disparity map of a single image to be processed, i.e., the second weight distribution map of the first disparity map is a first disparity map for a single image to be processed, that is, the first disparity maps of different images to be processed adopt different second weight distribution maps. Therefore, in the present disclosure, the second weight distribution map of the first disparity map is referred to as a local weight distribution map of the first disparity map. The local weight distribution map of the first disparity map is intended to describe respective local weight value of a plurality of disparity values (such as all the disparity values) of the first disparity map.

In an optional example of the present disclosure, a weight distribution map of the third disparity map is intended to describe respective weight values of a plurality of disparity values of the third disparity map. The weight distribution map of the third disparity map may include, but not limited to: a first weight distribution map of the third disparity map and a second weight distribution map of the third disparity map.

In an optional embodiment of the present disclosure, the first weight distribution map of the third disparity map is a weight distribution map set uniformly for the third disparity maps of a plurality of different images to be processed, i.e., the first weight distribution map of the third disparity map may be for the third disparity maps of a plurality of different images to be processed, that is, the third disparity maps of different images to be processed adopt a same first weight distribution map. Therefore, in the present disclosure, the first weight distribution map of the third disparity map may be referred to as a global weight distribution map of the third disparity map. The global weight distribution map of the third disparity map is intended to describe respective global weight value of a plurality of disparity values (such as all disparity values) of the third disparity map.

In an optional embodiment of the present disclosure, the second weight distribution map of the third disparity map is a weight distribution map set for the third disparity map of a single image to be processed, i.e., the second weight distribution map of the third disparity map is for the third disparity map of a single image to be processed, that is, the third disparity maps of different images to be processed adopt different second weight distribution maps. Therefore, in the present disclosure, the second weight distribution map of the third disparity map may be referred to as a local weight distribution map of the third disparity map. The local weight distribution map of the third disparity map is intended to describe respective local weight values of a plurality of disparity values (such as all the disparity values) of the third disparity map.

In an optional example of the present disclosure, the first weight distribution map of the first disparity map includes: at least two horizontally juxtaposed regions with different weight values. In an optional embodiment of the present disclosure, the relationship between a weight value of a left region and a weight value of a right region is typically depends on whether the image to be processed is taken as a left-eye image to be processed or a right-eye image to be processed.

For example, in a case that the image to be processed is taken as a left-eye image, for any two regions of the first weight distribution map of the first disparity map, a weight value of a right region is greater than a weight value of the left region. FIG. 6 illustrates a first weight distribution map of the disparity map illustrated in FIG. 3, and the first weight distribution map is divided into five regions, namely, region 1, region 2, region 3, region 4, and region 5, as illustrated in FIG. 6. A weight value of the region 1 is less than a weight value of the region 2, a weight value of the region 2 is less than a weight value of the region 3, a weight value of the region 3 is less than a weight value of the region 4, and a weight value of the region 4 is less than a weight value of the region 5. In addition, any region of the first weight distribution map of the first disparity map may have an equal weight value or different weight values. In the case where a region of the first weight distribution map of the first disparity map has different weight values, a weight value of the left part of the region is typically not greater than a weight value of the right part of the region. In an optional embodiment of the present disclosure, the weight value of the region 1 illustrated in FIG. 6 may be 0, that is, in the first disparity map, a disparity of the region 1 is completely incredible; the weight value of the region 2 may be increased, from left to right, gradually from 0 toward 0.5; the weight value of the region 3 is 0.5; the weight value of the region 4 can be increased, from the left to the right, from a value greater than 0.5 towards 1; and the weight value of the region 5 is 1, that is, a disparity of the region 5 of the first disparity map is completely credible.

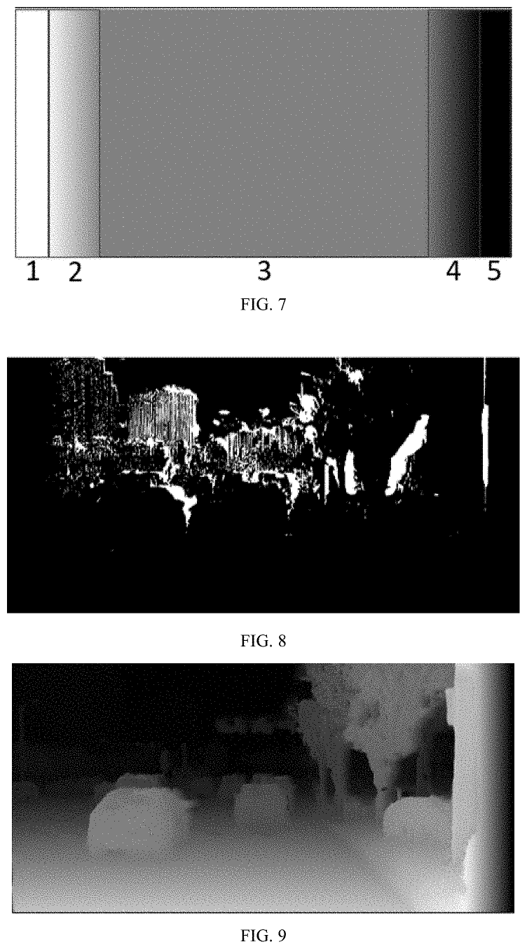

For another example, when the image to be processed is taken as a right-eye image, for any two regions of the first weight distribution map of the first disparity map, a weight value of the left region is greater than that of the right region. FIG. 7 illustrates the first weight distribution map of the first disparity map of the image to be processed which is taken as a right-eye image. The first weight distribution map is divided into five regions, namely, region 1, region 2, region 3, region 4 and region 5. A weight value of the region 5 is less than a weight value of the region 4, a weight value of the region 4 is less than a weight value of the region 3, a weight value of the region 3 is less than a weight value of the region 2, and a weight value of the region 2 is less than a weight value of the region 1. In addition, any region of the first weight distribution map of the first disparity map may have an equal weight value or different weight values. In the case that a region of the first weight distribution map of the first disparity map has different weight values, a weight value of the right part of the region is typically not greater than a weight value of the left part of the region. In an optional embodiment of the present disclosure, a weight value of the region 5 in FIG. 7 may be 0, that is, in the first disparity map, the disparity of the region 5 is completely incredible; the weight value of the region 4 may be gradually increased, from right to left, from 0 and towards 0.5; the weight value of the region 3 is 0.5; the weight value of the region 2 can be gradually increased, from right to left, from a value greater than 0.5 and towards 1; the weight value of the region 1 is 1, that is, the disparity corresponding to the region 1 of the first disparity map is completely credible.

In an optional embodiment of the present disclosure, the first weight distribution map of the third disparity map includes: at least two horizontally juxtaposed regions with different weight values. A relationship between a weight value of the left region and a weight value of the right region typically depends on whether the image to be processed is taken as a left-eye image or a right-eye image.

For example, when the image to be processed is taken as a left-eye image, for any two regions of the first weight distribution map of the third disparity map, a weight value of the right region is greater than a weight value of a left region. In addition, any region of the first weight distribution map of the third disparity map may have a same weight value, or may have different weight values. In the case that a region of the first weight distribution map of the third disparity map has different weight values, a weight value of the left part of the region is typically not greater than a weight value of the right part of the region.

For another example, in a case that the image to be processed is taken as a right-eye image, for any two regions of the first weight distribution map of the third disparity map, a weight value of the left region is greater than that of the right region. In addition, any region of the first weight distribution map of the third disparity map may have an equal eight value or different weight values. In a case that a region of the first weight distribution map of the third disparity map has different weight values, a weight value of the right part of the region is typically not greater than a weight value of the left part of the region.

In an optional embodiment of the present disclosure, a manner of setting the second weight distribution map of the first disparity map may include the following steps:

First, horizontal mirroring (for example, left mirroring or right mirroring) is performed on the first disparity map to generate a mirror disparity map. For ease of description, the mirror disparity map is referred to as a fourth disparity map.

Secondly, for a pixel in the fourth disparity map, in a case that a disparity value of the pixel is greater than the first variable for the pixel, a weight value of the pixel for the second weight distribution map of the first disparity map of the image to be processed is set to a first value, and otherwise, set to a second value. In the present disclosure, the first value is greater than the second value. For example, the first value may be 1, and the second value may be 0.

In an optional embodiment of the present disclosure, an example of the second weight distribution map of the first disparity map is illustrated in FIG. 8. Weight values of the white regions in FIG. 8 are all 1, which indicates that disparity values at these positions are completely credible. The weight values of the black regions in FIG. 8 are 0, which indicates that disparity values at these positions are completely incredible.

In an optional embodiment of the present disclosure, the first variable for the pixel may be set according to both a disparity value of a corresponding pixel in the first disparity map and a constant value greater than zero. For example, a product of the disparity value of the corresponding pixel in the first disparity map and a constant value greater than zero is taken as the first variable for the corresponding pixel in the fourth disparity map.

In an optional embodiment of the present disclosure, the second weight distribution map of the first disparity map may be expressed by the following Formula (1):

$${L}_{l} = \{ \begin{matrix}1 & if {d}_{flip}^{l} {}^{′} > {d}^{l} \cdot thresh 1 \\ 0 & else\end{matrix} \} \qquad Formula ( 1 )$$

In the above Formula (1), Lₗ represents the second weight distribution map of the first disparity map; d_{flip}^{l}′ represents the disparity value of the corresponding pixel in the fourth disparity map; d^{l} represents the disparity value of the corresponding pixel in the first disparity map; thresh1 represents a constant value greater than zero, thresh1 ranges from 1.1 to 1.5, such as thresh1=1.2 thresh2=1.25, and so on.

In an optional example, the second weight distribution map of the third disparity map can be set as follows: for a pixel in the first disparity map, in a case that a disparity value of the pixel in the first disparity map is greater than a second variable for the pixel, a weight value of the pixel for the second weight distribution map of the third disparity map is set to a first value, and otherwise, set to a second value otherwise. In an optional embodiment of the present disclosure, the first value is greater than the second value. For example, the first value may be 1 and the second value may be 0.

In an optional embodiment of the present disclosure, the second variable for the pixel may be set according to both a disparity value of a corresponding pixel in the fourth disparity map and a constant value greater than zero. For example, a left/right mirroring is performed on the first disparity map to generate a mirror disparity map, i.e., a fourth disparity map, and then, a product of a disparity value of a corresponding pixel in the fourth disparity map and a constant value greater than 0, is taken as the second variable for a corresponding pixel in the first disparity map.

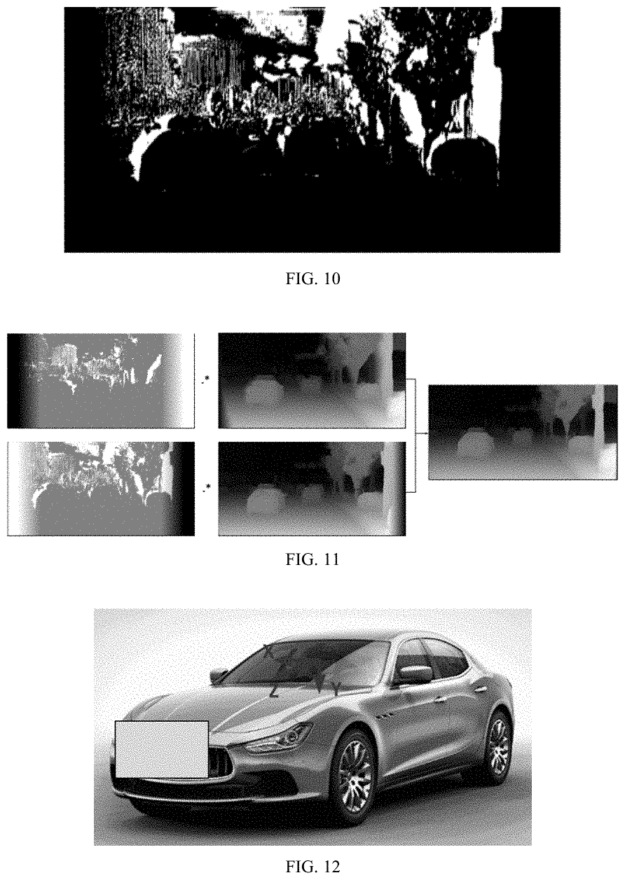

In an optional embodiment of the present disclosure, an example of the third disparity map generated based on the image to be processed of FIG. 2 is illustrated in FIG. 9. An example of the second weight distribution map of the third disparity map illustrated in FIG. 9 is illustrated in FIG. 10. Weight values of the white regions in FIG. 10 are all 1, which indicates that disparity values at these positions are completely credible. Weight values of the black regions in FIG. 10 are all 0, which indicates that disparity values at these positions are completely incredible.

In an optional embodiment of the present disclosure, the second weight distribution map of the third disparity map may be expressed by the following Formula (2):

$${L}_{l}^{′} = \{ \begin{matrix}1 & if {d}^{l} > {d}_{flip}^{l ′} \cdot thresh 2 \\ 0 & else\end{matrix} \} \qquad Formula ( 2 )$$

In the above Formula (2), Lₗ′ represents the second weight distribution map of the third disparity map; d_{flip}^{l}′ represents the disparity value of the corresponding pixel in the fourth disparity map; d^{l}′ represents the disparity value of the corresponding pixel in the first disparity map; thresh2 represents a constant value greater than zero, and a value range of thresh2 may be 1.1-1.5, for example, thresh2=1.2 or thresh2=1.25, and so on.

Step C: the first disparity map of the image to be processed is optimally adjusted according to both the weight distribution map of the first disparity map of the image to be processed and the weight distribution map of the third disparity map of the image to be processed, to acquire an optimally adjusted disparity map, which is a finally obtained disparity map of the image to be processed.

In an optional example of the present disclosure, a plurality of disparity values of the first disparity map may be adjusted with both the first weight distribution map of the first disparity map and the second weight distribution map of the first disparity map, to acquire an adjusted first disparity map; a plurality of disparity values of the third disparity map are adjusted with both the first weight distribution map of the third disparity map and the second weight distribution map of the third disparity map, to acquire an adjusted third disparity map; and then, the adjusted first disparity map and the adjusted third disparity map are combined to acquire an optimally adjusted first disparity map of the image to be processed.

In an optional embodiment of the present disclosure, an example of acquiring the optimally adjusted first disparity map of the image to be processed is as follows:

Firstly, the first weight distribution map of the first disparity map and the second weight distribution map of the first disparity map are combined to acquire a third weight distribution map. The third weight distribution map may be expressed by the following Formula (3):

Wₗ=Mₗ+Lₗ·0.5 Formula (3)

In the Formula (3), Wₗ represents the third weight distribution map; Mₗ represents the first weight distribution map of the first disparity map; Lₗ represents the second weight distribution map of the first disparity map; 0.5 may also be changed to be other constant values.

Secondly, the first weight distribution map of the third disparity map and the second weight distribution map of the third disparity map are combined to acquire a fourth weight distribution map. The fourth weight distribution map may be expressed by the following Formula (4):

Wₗ′=Mₗ′+Lₗ′·0.5 Formula (4)

In Formula (4), Wₗ′ represents the fourth weight distribution map, Mₗ′ represents the first weight distribution map of the third disparity map; Lₗ′ represents the second weight distribution map of the third disparity map; 0.5 may also be changed to be other constant values.

Thirdly, a plurality of disparity values of the first disparity map are adjusted according to the third weight distribution map, to acquire an adjusted first disparity map. For example, for a disparity value of a pixel in the first disparity map, the disparity value of the pixel is replaced with a product of the disparity value of the pixel and a weight value of a pixel at a corresponding position of the third weight distribution map. After all pixels in the first disparity map are subjected to the above replacement, the adjusted first disparity map is acquired.

And next, a plurality of disparity values of the third disparity map is adjusted according to the fourth weight distribution map, to acquire an adjusted third disparity map. For example, for a disparity value of a pixel in the third disparity map, a disparity value of the pixel is replaced with a product of the disparity value of the pixel and a weight value of a pixel at a corresponding position in the fourth weight distribution map. After all the pixels of the third disparity map are subjected to the above replacement, the adjusted third disparity map is acquired.

Finally, the adjusted first disparity map and the adjusted third disparity map are combined to finally acquire a disparity map of the image to be processed (that is, the final first disparity map). The finally acquired disparity map of the image to be processed may be expressed by the following Formula (5):

d_{final}=Wₗ·dₗ+Wₗ′·d_{flip}^{l}′ Formula (5)

In the Formula (5), d_{final} represents the finally acquired disparity map of the image to be processed (as illustrated in the first view on the right side of FIG. 11); Wₗ represents the third weight distribution map (as illustrated in the first view on the left at the top of FIG. 11); Wₗ′ represents the fourth weight distribution map (as illustrated the first view on the left at the bottom of FIG. 11); dₗ represents the first disparity map (as illustrated in the second view on the left at the top of FIG. 11); d_{flip}^{l}′ represents the third disparity map (illustrated in the second view on the left at the bottom of FIG. 11).

It should be noted that the sequence of the two steps of combining the first weight distribution map and the second weight distribution map is not limited in the present disclosure. For example, the two combining steps may be performed simultaneously or in sequence. In addition, the sequence of adjusting the disparity values of the first disparity map and adjusting the disparity values of the third disparity map is not limited in the present disclosure. For example, the two adjusting steps can be performed simultaneously or in sequence.

In an optional embodiment of the present disclosure, in a case that the image to be processed is taken as a left-eye image, phenomena such as missing left-side disparity and the left edge of the object being blocked usually exist. These phenomena make disparity values of corresponding regions in the disparity map of the image to be processed inaccurate. Similarly, in a case that the image to be processed is taken as a right-eye image, phenomena such as missing right-side disparity and the right edge of the object being blocked usually exist. These phenomena make disparity values of corresponding regions in the disparity map of the image to be processed inaccurate. In the present disclosure, the image to be processed is left/right mirrored, the disparity map of the mirrored image is also mirrored, and the disparity map of the image to be processed is adjusted with the disparity map that has been mirrored, thus, the phenomena that the disparity values of the corresponding regions in the disparity map of the image to be processed are inaccurate is mitigated, which benefits to improve accuracy of moving object detection.

In an optional example of the present disclosure, in an application scenario where the image to be processed is a binocular image, a manner of acquiring the first disparity map of the image to be processed according to the present disclosure includes, but not limited to: acquiring a first disparity map of the image to be processed through stereo matching. For example, the first disparity of the image to be processed may be acquired through a stereo matching algorithm, such as Block Matching (BM) algorithm, Semi-Global Block Matching (SGBM) algorithm, or Graph Cuts (GC) algorithm or the like. For another example, disparity processing is performed on the image to be processed by a convolutional neural network, which is configured to acquire a disparity map of a binocular image, to acquire the first disparity map of the image to be processed.

In an optional example of the present disclosure, after acquiring the first disparity map of the image to be processed, depth information of pixels of the image to be processed may be acquired through the following Formula (6):

$$Depth = \frac{{f}_{x} \times b}{Disparity} \qquad Formula ( 6 )$$

In the above Formula (6), Depth represents a depth value of a pixel; fₓ is a known value representing a focal length of the image pickup device in the horizontal direction (X-axis direction of the three-dimensional coordinate system); b is a known value representing a baseline of the binocular image sample which is adopted by the convolutional neural network which is configured to acquire disparity map, and b is a calibrated parameter of the binocular image pickup device; and Disparity represents a disparity of a pixel.

S110: Optical flow information between the image to be processed and a reference image is acquired.

In an optional example of the present disclosure, the image to be processed and the reference image may be two images that are collected by an image pickup device in a continuous photographing mode (such as multiple continuous photographing or video recording) and have a timing sequence relationship. Time interval between capturing the two images is usually short to ensure that most contents of the two images are the same. For example, the time interval between capturing the two images may be a time interval between two adjacent video frames. For another example, the time interval between capturing the two images may be a time interval between two adjacent photos in the continuous photographing mode of the image pickup device. In an optional embodiment of the present disclosure, the image to be processed may be a video frame (such as the current video frame) of a video collected by the image pickup device, and the reference image for the image to be processed is another video frame of the video, for example, the reference image is a preceding video frame of the current video frame. In the present disclosure, the case that the reference image is a video frame subsequent to the current video frame is not excluded. In an optional embodiment of the present disclosure, the image to be processed may be one of a plurality of images collected by the image pickup device in a continuous photographing mode, and the reference image for the image to be processed may be another image among the plurality of images, such as a preceding image or a subsequent image of the image to be processed. The image to be processed and the reference image in the present disclosure may both be RGB (Red Green Blue, red green blue) images or the like. The image pickup device in the present disclosure may be an image pickup device provided on a moving object, for example, an image pickup device mounted on vehicles, trains, airplanes, and other transportations.

In an optional example of the present disclosure, the reference image is typically a monocular image. That is, the reference image is usually an image collected by a monocular image pickup device. In the case that the image to be processed and the reference image are both monocular images, moving object detection can be achieved in the present disclosure without a binocular image pickup device, thereby reducing the cost for moving object detection.

In an optional example of the present disclosure, the optical flow information between the image to be processed and the reference image may be considered to be a two-dimensional motion field of the pixels of the image to be processed and the reference image, and the optical flow information does not characterize real movement of the pixel in the three-dimension space. In the present disclosure, in the process of acquiring the optical flow information between the image to be processed and the reference image, posture change information of the image pickup device between capturing the image to be processed and capturing the reference image, is introduced, that is, the optical flow information between the image to be processed and the reference image is acquired according to the posture change information of the image pickup device between capturing the image to be processed and capturing the reference image, which eliminates interference introduced due to the posture change information of the image pickup device. In the present disclosure, a manner of acquiring the optical flow information between the image to be processed and the reference image according to the posture change information of the image pickup device may comprises following steps:

Step 1. Posture change information of the image pickup device between capturing the image to be processed and capturing the reference image is acquired.

In an optional embodiment of the present disclosure, the posture change information refers to the difference between the posture of the image pickup device when the image to be processed is collected and the posture when the reference image is collected. The posture change information is a posture change information based on the three-dimensional space. The posture change information may include translation information of the image pickup device and rotation information of the image pickup device. The translation information of the image pickup device may include displacement amount of the image pickup device on three coordinate axes (for example, the coordinate system illustrated in FIG. 12). The rotation information of the image pickup device may be a rotation vector based on Roll, Yaw, and Pitch. In other words, the rotation information of the image pickup device may include rotation component vectors based on the three rotation directions of Roll, Yaw, and Pitch.

For example, the rotation information of the image pickup device can be expressed as the following Formula (7):

$$R = [ \begin{matrix}{R}_{11} & {R}_{12} & {R}_{13} \\ {R}_{21} & {R}_{22} & {R}_{23} \\ {R}_{31} & {R}_{32} & {R}_{33}\end{matrix} ] \qquad Formula ( 7 )$$

In the above Formula (7):

R represents rotation information, which is a 3×3 matrix, R₁₁ represents cos α cos γ−cos β sin α sin γ,

R₁₂ represents −cos β cos γ sin α−cos α sin γ represents R₁₃ sin α sin β,

R₂₁ represents cos γ sin α+cos α cos β sin γ R₂₂ represents cos α cos β cos γ−sin α sin γ,

R₂₃ sin α sin β R₃₁ represents sin β sin γ, R₃₂ represents cos γ sin β, R₃₃ represents cos β, and

Euler angle (α,β,γ) represents the rotation angle based on Roll, Yaw and Pitch.

In an optional embodiment of the present disclosure, the posture change information of the image pickup device between capturing the image to be processed and capturing the reference image may be acquired through vision technology, for example, Simultaneous Localization And Mapping (SLAM). Further, in the present disclosure, the posture change information of the image pickup device may be acquired through an RGBD model based on open source ORB-SLAM system, wherein RGBD stands for Red Green Blue Depth, ORB stands for Oriented FAST and Rotated BRIEF, which is a descriptor, and SLAM stands for Simultaneous Localization And Mapping. For example, an image to be processed (an RGB image), a depth map of the image to be processed, and a reference image (an RGB image) are input into an RGBD model, to acquire posture change information according to output of the RGBD model. In addition, the posture change information may also be acquired through other manners in the present disclosure. For example, the posture change information may be obtained through GPS (Global Positioning System) and an angular velocity sensor.

In an optional embodiment of the present disclosure, the posture change information may be expressed by a homogeneous matrix of 4×4 as indicated by the following Formula (8):

$${T}_{l}^{c} = {[ \begin{matrix}R & t \\ 0 & 1\end{matrix} ]}_{4 \times 4} = {[ \begin{matrix}{R}_{11} & {R}_{12} & {R}_{13} & {t}_{x} \\ {R}_{21} & {R}_{22} & {R}_{23} & {t}_{y} \\ {R}_{31} & {R}_{32} & {R}_{33} & {t}_{z} \\ 0 & 0 & 0 & 1\end{matrix} ]}_{4 \times 4} \qquad Formula ( 8 )$$

In the above Formula (8), Tₗ^{c} represents the posture change information of the image pickup device between capturing the image to be processed (for example, the current video frame c) and capturing the reference image (the preceding video frame l of the current video frame c), such as a posture change matrix; R represents the rotation information of the image pickup device, which is 3×3 Matrix of

$$[ \begin{matrix}{R}_{11} & {R}_{12} & {R}_{13} \\ {R}_{21} & {R}_{22} & {R}_{23} \\ {R}_{31} & {R}_{32} & {R}_{33}\end{matrix} ] ;$$

t represents the translation information of the image pickup device, that is, a translation vector; t is expressed by three translation components tₓ, t_{y} and t_{z}, wherein tₓ represents a translation component in the X axis direction, t_{y} represents a translation component in the Y axis direction, and t_{z} represents a translation component in the Z-axis direction.

Step 2: a correspondence between pixel values of the pixels in the image to be processed and pixel values of the pixels in the reference image is established according to the posture change.

In an optional embodiment of the present disclosure, in a case that the image pickup device is in motion, the posture of the image pickup device when capturing the image to be processed is usually different from the posture of the image pickup device when capturing the reference image. Therefore, a three-dimensional coordinate system corresponding to the image to be processed (that is, the three-dimensional coordinate system of the image pickup device when capturing the image to be processed) is different from a three-dimensional coordinate system corresponding to the reference image (that is, the three-dimensional coordinate system of the image pickup device when capturing the reference image). In the present disclosure, in the case of establishing the correspondence, three dimensional spatial positions of the pixels may be converted first, such that the pixels of the image to be processed and the pixels of the reference image are within the same three-dimensional coordinate system.

In an optional embodiment of the present disclosure, first coordinates of the pixels (for example, all the pixels) of the image to be processed within a three-dimensional coordinate system of the image pickup device corresponding to the image to be processed is first acquired according to the acquired depth information and a parameter of the image pickup device (known values). That is, in the present disclosure, the pixels of the image to be processed are first converted into a three-dimensional space, to acquire the three-dimensional coordinates of the pixels (i.e., three-dimensional coordinates). For example, in the present disclosure, three-dimensional coordinates of a pixel of the image to be processed may be acquired through the following Formula (9):

$$\{ \begin{matrix}Z = \frac{{f}_{x} b}{Disparity} \\ X = \frac{Z ( u - {c}_{x} )}{{f}_{x}} \\ Y = \frac{Z ( v - {c}_{y} )}{{f}_{y}}\end{matrix} \qquad Formula ( 9 )$$

In the above Formula (9), Z represents a depth value of the pixel, and X, Y, and Z represent the three-dimensional coordinates of the pixel (i.e., the first coordinates); fₓ represents the focal length of the image pickup device in the horizontal direction (X-axis direction of the three-dimensional coordinate system); f_{y} represents the focal length of the image pickup device in the vertical direction (the Y-axis direction of the three-dimensional coordinate system); (u,v) represents two-dimensional coordinates of the pixel in the image to be processed; cₓ,c_{y} represents the coordinates of the principal point of the image pickup device; Disparity represents a disparity of the pixel.

In an optional embodiment of the present disclosure, assume that any pixel of the image to be processed is expressed as pᵢ(uᵢ,vᵢ), and after a plurality of pixels are converted into three-dimensional space, any pixel is expressed as Pᵢ(Xᵢ,Yᵢ,Zᵢ), Then, a three-dimensional space point set constituted by a plurality of pixels (such as all the pixels) in the three-dimensional space can be expressed as {Pᵢ^{c}}. Pᵢ^{c} represents three-dimensional coordinates of the i-th pixel of the image to be processed, namely Pᵢ(Xᵢ,Yᵢ,Zᵢ); C represents the image to be processed, and the value range of i depends on the number of the plurality of pixels. For example, if the number of the plurality of pixels is N (N is an integer greater than 1), the value range of i may be 1 to N or 0 to N−1.

In an optional embodiment of the present disclosure, after acquiring the first coordinates of the plurality of pixels (such as all pixels) of the image to be processed, the first coordinates of the plurality of pixels are converted into a three-dimensional coordinate system of the image pickup device corresponding to the reference image according to the posture change, to acquire second coordinates of the plurality of pixels. For example, in the present disclosure, the second coordinates of any pixel in the image to be processed may be acquired through the following Formula (10):

Pᵢ^{l}=Tₗ^{c}Pᵢ^{c} Formula (10)

In the above Formula (10), Pᵢ^{l} represents the second coordinates of the i-th pixel in the image to be processed, Tₗ^{c} represents posture change information of the image pickup device between capturing the image to be processed (such as the current video frame c) and capturing the reference image (such as the preceding video frame l of the current video frame c), such as a posture change matrix, namely

$${[ \begin{matrix}R & t \\ 0 & 1\end{matrix} ]}_{4 \times 4} ;$$

and Pᵢ^{c} represents the first coordinates of the i-th pixel in the image to be processed.

In an optional embodiment of the present disclosure, after acquiring the second coordinates of the plurality of pixels in the image to be processed, a projected two-dimensional coordinates of the image to be processed that has been converted into the three-dimensional coordinate system corresponding to the reference image is acquired by performing a projection on the second coordinates of the plurality of pixels based on the two-dimensional coordinate system of the two-dimensional image. For example, in the present disclosure, the projected two-dimensional coordinates may be acquired through the following Formula (11):

$$\{ \begin{matrix}u = {f}_{x} \frac{X}{Z} + {c}_{x} \\ v = {f}_{y} \frac{Y}{Z} + {c}_{y}\end{matrix} \qquad Formula ( 11 )$$

In the above Formula (11), (u,v) represents the projected two-dimensional coordinates of the pixels in the image to be processed; fₓ represents the focal length of the image pickup device in the horizontal direction (X-axis direction of the three-dimensional coordinate system); f_{y} represents the focal length of the image pickup device in the vertical direction (the Y-axis direction of the three-dimensional coordinate system); cₓ,c_{y} represents the coordinates of the principal point of the image pickup device; (X,Y,Z) represents the second coordinates of the pixel in the image to be processed.

In an optional embodiment of the present disclosure, after acquiring the projected two-dimensional coordinates of the pixels in the image to be processed, a correspondence between pixel values of the pixels in the image to be processed and pixel values of the pixels in the reference image may be established according to both the projected two-dimensional coordinates and the two-dimensional coordinates in the reference image. The correspondence may express, for any pixel at the same position of the image formed by projecting two-dimensional coordinates and of the reference image, the pixel values of the pixel in the image to be processed and the pixel values of the pixel in the reference image.

Step 3: A conversion is performed on the reference image according to the correspondence.

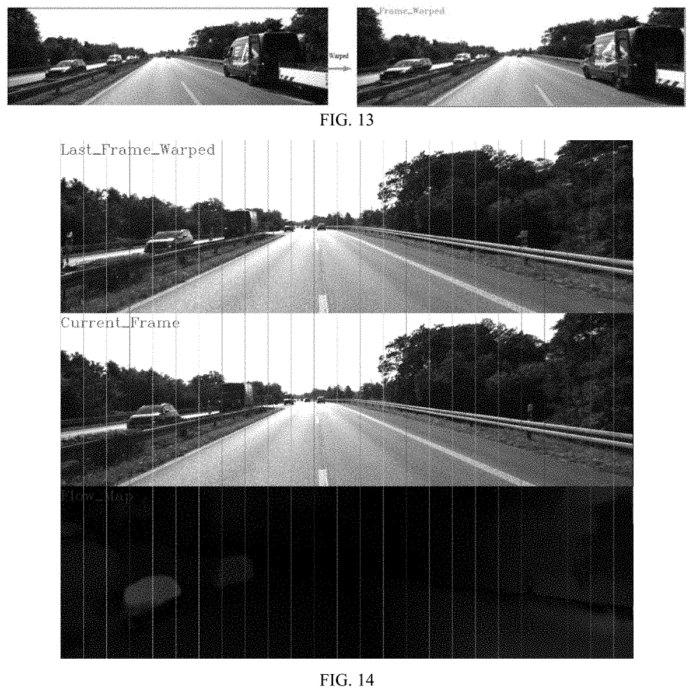

In an optional embodiment of the present disclosure, warping is performed on the reference image with the correspondence, so that the reference image is converted into the image to be processed. FIG. 13 illustrates an example of performing a warping on the reference image. As illustrated in FIG. 13, the left view is a reference image, and the right view is an image generated by performing a warping on the reference image.

Step 4. The optical flow information between the image to be processed and the reference image is calculated according to the image to be processed and the reference image that has been subject to conversion.

In an optional embodiment of the present disclosure, the optical flow information includes, but not limited to density optical flow information. For example, the optical flow information is calculated for all pixels of the image. The optical flow information may be acquired through vision technology in the present disclosure. For example, the optical flow information may be acquired through OpenCV (Open Source Computer Vision Library). Further, in the present disclosure, the image to be processed and the reference image that has been subject to conversion may be input into a model based on OpenCV, which outputs optical flow information between the two input images, so that the optical flow information between the image to be processed and the reference image may be acquired. The algorithm adopted in the model for calculating optical flow information includes but not limited to Gunnar Farneback algorithm.

In an optional embodiment of the present disclosure, it is assumed that the optical flow information of any pixel in the image to be processed acquired in the present disclosure may be expressed as I_{of} (Δu, Δv), Then, the optical flow information of the pixel typically satisfies the following Formula (12):

Iₜ(uₜ,vₜ)+I_{of}(Δu,Δv)=Iₜ₊₁(uₜ₊₁,vₜ₊₁) Formula (12)

In the above Formula (12), Iₜ(uₜ,vₜ) represents a pixel of the reference image; Iₜ₊₁ (uₜ,vₜ₊₁) represents a pixel at a corresponding position of the image to be processed.

In an optional embodiment of the present disclosure, the reference image that has been subject to Warping (such as the preceding video frame that has been subject to warping), the image to be processed (such as the current video frame) and the calculated optical flow information are illustrated in FIG. 14. The upper view of FIG. 14 is the reference image that has been subject to warping, the middle view of FIG. 14 is the image to be processed, and the lower view of FIG. 14 is the optical flow information between the image to be processed and the reference image, that is, the optical flow information of the image to be processed with respect to the reference image. The vertical line in FIG. 14 is added for convenience of comparing details.

S120: a three-dimensional motion field of the image to be processed with respect to the reference image is acquired according to both the depth information and the optical flow information.

In an optional example of the present disclosure, after acquiring the depth information and the optical flow information, the three-dimensional motion field of the pixels (such as all the pixels) of the image to be processed with respect to the reference image (which may be referred to as 3D motion field of pixels in the image to be processed). The three-dimensional motion field in the present disclosure can be considered as: a three-dimensional motion field generated by scene motion in a three-dimensional space. In other words, the three-dimensional motion field of the pixels of the image to be processed may be considered as: three-dimensional spatial displacement of the pixels of the image to be processed with respect to the reference image. The three-dimensional motion field may be represented by Scene Flow.

In an optional embodiment of the present disclosure, in the present disclosure, a scene flow of a plurality of pixels of the image to be processed I_{sf}(ΔX, ΔY, ΔZ) may be expressed by the following Formula (13):

$$\{ \begin{matrix}Δ {I}_{d e p t h} = Δ Z \\ Δ u = {f}_{x} \frac{Δ X}{Δ Z} + {c}_{x} ⇒ \\ Δ v = {f}_{y} \frac{Δ Y}{Δ Z} + {c}_{y}\end{matrix} \{ \begin{matrix}Δ Z = Δ {I}_{d e p t h} \\ Δ X = \frac{Δ {I}_{d e p t h} ( Δ u - {c}_{x} )}{{f}_{x}} \\ Δ Y = \frac{Δ {I}_{d e p t h} ( Δ v - {c}_{y} )}{{f}_{y}}\end{matrix} \qquad Formula ( 13 )$$

In the above Formula (13), (ΔX, ΔY, ΔZ) represents displacement of any pixel of the image to be processed in the three coordinate axis directions of the three-dimensional coordinate system; ΔI_{depth} represents a depth value of the pixel, (Δu, Δv) represents optical flow information of the pixel, that is, the displacement of the pixel in the two-dimensional image between the image to be processed and the reference image; fₓ represents the focal length of the image pickup device in the horizontal direction (X-axis direction of the three-dimensional coordinate system); f_{y} represents the focal length of the image pickup device in the vertical direction (the Y-axis direction in the three-dimensional coordinate system); cₓ,c_{y} represents the coordinates of the principal point of the image pickup device.

S130: A moving object involved in the image to be processed is determined according to the three-dimensional motion field.

In an optional example of the present disclosure, three-dimensional movement information of an object involved in the image to be processed may be determined according to the three-dimensional motion field. The three-dimensional movement information of the object may indicate whether the object is a moving object. In an optional embodiment of the present disclosure, the three-dimensional movement information of the pixels in the image to be processed may be acquired first according to the three-dimensional motion field; and then, a clustering is performed on the pixels according to the three-dimensional movement information of the pixels; and finally, the three-dimensional movement information of an object involved in the image to be processed is determined according to a result of the clustering, to determine a moving object involved in the image to be processed.

In an optional example of the present disclosure, the three-dimensional movement information of the pixels in the image to be processed may include, but not limited to: three-dimensional speeds of a plurality of pixels (such as all the pixels) of the image to be processed. The speeds here are typically in a form of a vector, that is, the speed of a pixel in the present disclosure can reflect the speed magnitude of the pixel and the speed direction of the pixel. In the present disclosure, the three-dimensional movement information of the pixels in the image to be processed can be easily acquired by means of the three-dimensional motion field.

In an optional example of the present disclosure, the three-dimensional space in the present disclosure includes: a three-dimensional space based on a three-dimensional coordinate system. The three-dimensional coordinate system may be: the three-dimensional coordinate system of the image pickup device that captures the image to be processed. The Z axis of the three-dimensional coordinate system is typically the optical axis of the image pickup device, that is, the depth direction. In an application scene that the image pickup device is mounted on a vehicle, an example of the X axis, the Y axis, the Z axis and the origin of the three-dimensional coordinate system of the present disclosure is illustrated in FIG. 12. From the perspective of the vehicle itself in FIG. 12 (that is, the image pickup device facing the front of the vehicle), the X-axis points to the right in the horizontal direction, the Y-axis points to the bottom of the vehicle, the Z-axis points to the front of the vehicle, and the origin of the three-dimensional coordinate system is positioned at the optical center of the image pickup device.

In an optional example of the present disclosure, speeds of a pixel of the image to be processed in the three coordinate axis directions of a three-dimensional coordinate system of the image pickup device corresponding to the image to be processed may be calculated according to both the three-dimensional motion field and time difference Δt between capturing the image to be processed and capturing the reference image by the image pickup device. Further, in the present disclosure, the speed may be acquired through the following Formula (14):

$$\{ \begin{matrix}{v}_{x} = \frac{Δ X}{Δ t} \\ {v}_{y} = \frac{Δ Y}{Δ t} \\ {v}_{z} = \frac{Δ Z}{Δ t}\end{matrix} \qquad Formula ( 14 )$$

In the above Formula (14), vₓ, v_{y} and v_{z} respectively represent the speed of a pixel of the image to be processed in the three coordinate axis directions of the three-dimensional coordinate system of the image pickup device corresponding to the image to be processed; (ΔX, ΔY, ΔZ) represents displacements of the pixel of the image to be processed in the three coordinate axis directions of the three-dimensional coordinate system of the image pickup device corresponding to the image to be processed; Δt represents time difference between capturing the image to be processed and capturing the reference image by the image pickup device.

The magnitude |v| of the above speed may be expressed by the following Formula (15):

|v|=vₓ²+v_{y}²+v_{z}² Formula (15)

The direction \vec{v} of the above speed may be expressed by the following Formula (16):

$$\vec{v} = ( \frac{{v}_{x}}{\vert v \vert} , \frac{{v}_{y}}{\vert v \vert} , \frac{{v}_{z}}{\vert v \vert} ) \qquad Formula ( 16 )$$

In an optional example of the present disclosure, a motion region of the image to be processed may be first determined, and a clustering is performed on the pixels of the motion region. For example, a clustering is performed on the pixels of the motion region according to three-dimensional movement information of the pixels in the motion region. For another example, a clustering is performed on pixels of the motion region according to the three-dimensional movement information of pixels in the motion region and three-dimensional positions of pixels. In an optional embodiment of the present disclosure, the motion region in the image to be processed may be determined through a motion mask. For example, in the present disclosure, a motion mask of the image to be processed may be acquired according to the three-dimensional movement information of the pixels.

In an optional embodiment of the present disclosure, the speeds magnitude of a plurality of pixels (such as all the pixels) of the image to be processed may be filtered with a preset speed threshold, to form a motion mask of the image to be processed according to the filter result. For example, in the present disclosure, the motion mask of the image to be processed may be obtained through the following Formula (17):

$${I}_{m o t i o n} = \{ \begin{matrix}1 ( \vert v \vert \geq v\_thresh ) \\ 0 ( \vert v \vert < v\_thresh )\end{matrix} \qquad Formula ( 17 )$$

In the above Formula (17), Iₘₒₜᵢₒₙ represents a pixel in the motion mask; in a case that the speed magnitude |v| of the pixel is greater than or equal to the preset speed threshold v_thresh, a value of the pixel is 1, indicating that the pixel belongs to the motion region of the image to be processed; otherwise, the value of the pixel is 0, indicating that the pixel does not belong to the motion region of the image to be processed.

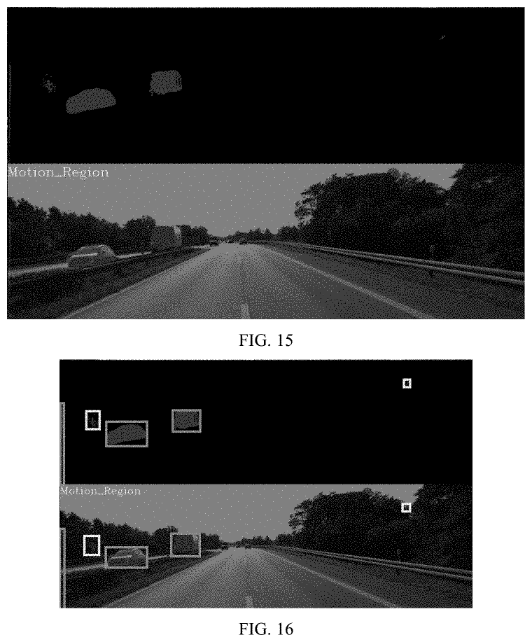

In an optional embodiment of the present disclosure, a region composed of pixels with a value of 1 in the motion mask as a motion region, and the size of the motion mask is as same as the size of the image to be processed. Therefore, in the present disclosure, the motion region of the image to be processed may be determined according to the motion region of the motion mask. An example of the motion mask in the present disclosure is illustrated in FIG. 15. The lower view of FIG. 15 illustrates the image to be processed, and the upper view of FIG. 15 illustrates the motion mask of the image to be processed. The black part in the upper view is the non-motion region, and the gray part in the upper view is the motion region. The motion region in the upper view is substantially consistent with the moving objects in the lower view. In addition, as the technology of acquiring depth information and posture change and calculating optical flow information improves, the accuracy of the present disclosure for determining the motion region of the image to be processed will be improved as well.

In an optional example of the present disclosure, in a case of performing a clustering according to the three-dimensional spatial position and movement information of the pixels in the motion region, the three-dimensional spatial position and the movement information of the pixels in the motion region are first standardized, so that the three-dimensional coordinates of the pixels in the motion region are converted into a predetermined coordinate interval (such as [0, 1]), and the speed of the pixels of the motion region is converted into a predetermined speed interval (such as [0, 1]). And then, a density clustering is performed with the converted three-dimensional space coordinates and the converted speed, to acquire at least one class cluster.

In an optional embodiment of the present disclosure, the standardization includes, but not limited to min-max standardization, and Z-score standardization, and etc.

For example, the min-max standardization for the three-dimensional spatial position information of the pixels of the motion region can be expressed by the following Formula (18), and the min-max standardization for the movement information of the pixels in the motion region may be expressed by the following Formula (19):

$$\{ \begin{matrix}{X}^{*} = \frac{X - {X}_{min}}{{X}_{max} - {X}_{min}} \\ {Y}^{*} = \frac{Y - {Y}_{min}}{{y}_{max} - {y}_{min}} \\ {Z}^{*} = \frac{Z - {Z}_{min}}{{Z}_{max} - {Z}_{min}}\end{matrix} \qquad Formula ( 18 )$$

In the above Formula (18), (X,Y,Z) represents the three-dimensional spatial position information of a pixel of the motion region of the image to be processed; (X*,Y*,Z*) represents the three-dimensional spatial position information of the pixel that has been subject to standardization; (Xₘᵢₙ, Yₘᵢₙ, Zₘᵢₙ) represents the minimum X coordinate, the minimum Y coordinate, and the minimum Z coordinate of the three-dimensional spatial position information of all pixels of the motion region; (Xₘₐₓ,Yₘₐₓ,Zₘₐₓ) represents the maximum X coordinate, the maximum Y coordinate, and the maximum Z coordinate of the three-dimensional spatial position information of all pixels of the motion region.

$$\{ \begin{matrix}{v}_{x}^{*} = \frac{{v}_{x} - {v}_{x min}}{{v}_{x max} - {v}_{x min}} \\ {v}_{y}^{*} = \frac{{v}_{y} - {v}_{ymin}}{{v}_{ymax} - {v}_{ymin}} \\ {v}_{z}^{*} = \frac{{v}_{z} - {v}_{z min}}{{v}_{z max} - {v}_{zmin}}\end{matrix} \qquad Formula ( 19 )$$

In the above Formula (19), (vₓ,v_{y},v_{z}) represents the three-dimensional speeds of the pixels of the motion region in the three coordinate axis directions; (vₓ*,v_{y}*,v_{z}*) represents a speed after the min max standardization of (vₓ,v_{y},v_{z}); (v_{x min},v_{y min},v_{z min}) represents the minimum three-dimensional speed of all pixels of the motion region in the three coordinate axis directions; (v_{x max},v_{y max},v_{z max}) represents the maximum three-dimensional speed of all pixels of the motion region in the three coordinate axis directions.

In an optional example of the present disclosure, clustering algorithms adopted for the clustering includes, but not limited to a density clustering algorithm, for example, Density-Based Spatial Clustering of Applications with Noise (DBSCAN) and so on. Each class cluster acquired by clustering corresponds to an instance of moving object, that is, each class cluster may be regarded as a moving object involved in the image to be processed.

In an optional example of the present disclosure, for any class cluster, the speed magnitude and the speed direction of a moving object instance corresponding to the class cluster may be determined according to speed magnitudes and speed directions of a plurality of pixels of the class cluster (for example, all the pixels). In an optional example of the present disclosure, the speed magnitude and the speed direction of the moving object instance corresponding to the class cluster may be expressed by average speed and average direction of all pixels of the class cluster. For example, the speed magnitude and the speed direction of the moving object instance corresponding to a class cluster may be expressed by the following Formula (20):

$$\{ \begin{matrix}\vert {v}_{o} \vert = \frac{1}{n} {\sum }_{i = 1 ∼ n} \vert {v}_{i} \vert \\ \vec{{v}_{o}} = \frac{1}{n} {\sum }_{i = 1 ∼ n} \vec{{v}_{i}}\end{matrix} \qquad Formula ( 20 )$$

In the above Formula (20), |vₒ| represents the speed magnitude of the moving object instance corresponding to a class cluster obtained by clustering; |vᵢ| represents the speed magnitude of the i-th pixel of the class cluster; n represents the number of pixels contained in the class cluster; \vec{v}ₒ represents the speed direction of the moving object instance corresponding to the class cluster; \vec{v}ᵢ represents the speed direction of the i-th pixel of the class cluster.

In an optional example of the present disclosure, a moving object bounding box in the image to be processed for the moving object instance corresponding to the class cluster may be determined according to position information of a plurality of pixels of a class cluster (for example, all the pixels) in a two-dimensional image (i.e., two-dimensional coordinates in the image to be processed). For example, in the present disclosure, for a class cluster, the maximum column coordinates uₘₐₓ and the minimum column coordinates uₘᵢₙ of all pixels of the class cluster in the image to be processed may be calculated, and the maximum row coordinate vₘₐₓ and the minimum row coordinates vₘᵢₙ of all pixels of the class cluster may be calculated (Note: It is assumed that the origin of the image coordinate system is positioned at the upper left corner of the image). In the present disclosure, the coordinates of the acquired moving object bounding box in the image to be processed may be expressed as (uₘᵢₙ,vₘᵢₙ,uₘₐₓ,vₘₐₓ).

In an optional embodiment of the present disclosure, an example of the determined moving object bounding box in the image to be processed is illustrated in the lower view of FIG. 16. In a case that the moving object bounding box is illustrated in the moving mask, it is as illustrated in the upper view of FIG. 16. The plurality of rectangular boxes in the upper and the lower views of FIG. 16 are all moving object bounding boxes acquired in the present disclosure.

In an optional example of the present disclosure, the three-dimensional position information of the moving object may also be determined according to the three-dimensional position information of a plurality of pixels of the same class cluster. The three-dimensional position information of the moving object includes but not limited to coordinates of the moving object on the horizontal coordinate axis (X coordinate axis), coordinates of the moving object on the depth coordinate axis (Z coordinate axis), a height of the moving object in the vertical direction (i.e., the height of the moving object), and etc.

In an embodiment of the present disclosure, the distances between all pixels of a class cluster and the image pickup device may be determined firstly according to the three-dimensional position information of all pixels of the same class cluster, and then the three-dimensional position information of the pixel with minimum distance is taken as the three-dimensional position information of the moving object.

In an optional embodiment of the present disclosure, a distance between each of a plurality of pixels of a class cluster and the image pickup device is calculated through the following Formula (21), and the minimum distance is selected:

dₘᵢₙ=min(√Xᵢ²+Zᵢ²) Formula (21)

In the above Formula (21), dₘᵢₙ represents the minimum distance; Xᵢ represents the X coordinate of the i-th pixel of a class cluster; Zᵢ represents the Z coordinate of the i-th pixel of the class cluster.

After determining the minimum distance, the X coordinate and the Z coordinate of the pixel with the minimum distance may be taken as the three-dimensional position information of the moving object, as expressed in the following Formula (22):

O_{X}=X_{close}

O_{Z}=Z_{close} Formula (22)

In the above Formula (22), O_{X} represents the coordinate of the moving object on the horizontal coordinate axis, that is, the X coordinate of the moving object; O_{Z} represents the coordinate of the moving object on the depth coordinate axis (Z coordinate axis), that is, the Z coordinate of the moving object; X_{close} represents the calculated X coordinate of the pixel with the minimum distance; Z_{close} represents the calculated Z coordinate of the pixel with the minimum distance.

In an optional embodiment of the present disclosure, the height of the moving object may be calculated through the following Formula (23):

O_{H}=Yₘₐₓ−Yₘᵢₙ Formula (23)

In the above Formula (23), O_{H} represents the height of the moving object in the three-dimensional space; Yₘₐₓ represents the maximum Y coordinate of all pixels of a class cluster in the three-dimensional space; Yₘᵢₙ represents the minimum Y coordinate of all pixels of a class cluster in the three-dimensional space.

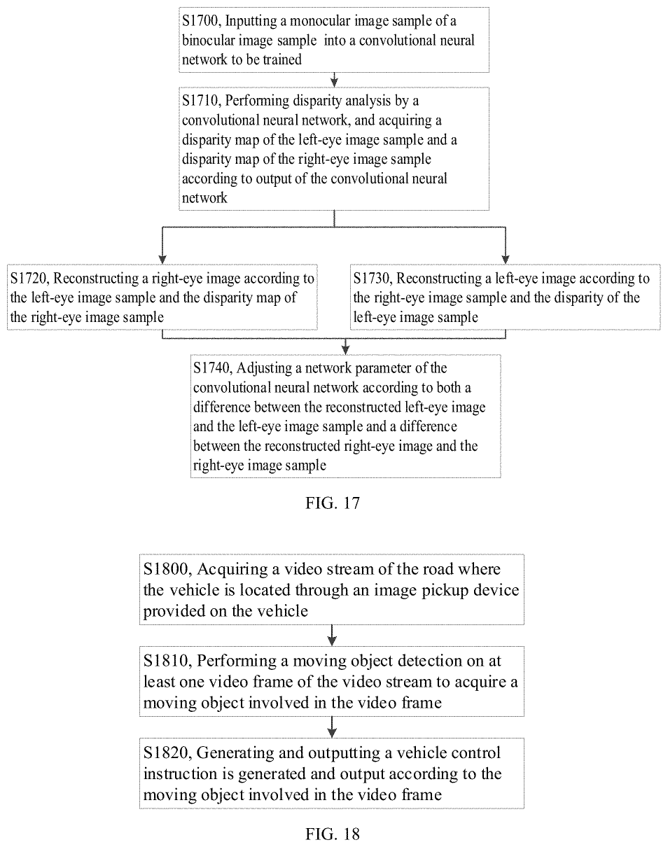

FIG. 17 illustrates a flowchart of training a convolutional neural network according to an embodiment of the present disclosure.

S1700. a monocular image sample of a binocular image sample is input into a convolutional neural network to be trained.

In an optional embodiment of the present disclosure, the image sample input into the convolutional neural network may always be a left-eye image sample of binocular image samples, or a right-eye image sample of binocular image samples. In the case that the image sample input into the convolutional neural network is always the left-eye image sample of the binocular image samples, the successfully trained convolutional neural network will take an input image to be processed as the left-eye image to be processed in testing or actual application scenarios. In the case that the image sample input into the convolutional neural network is always the right-eye image sample of the binocular image sample, the successfully trained convolutional neural network will take an input image to be processed as the left-eye image to be processed in testing or actual application scenarios.

S1710: Disparity analysis is performed by a convolutional neural network, and a disparity map of the left-eye image sample and a disparity map of the right-eye image sample are acquired based on output of the convolutional neural network.

S1720: A right-eye image is reconstructed according to the left-eye image sample and the disparity map of the right-eye image sample.

In an optional embodiment of the present disclosure, a manner of reconstructing the right-eye image includes but not limited to: performing a re-projection on the left-eye image sample and the disparity map of the right-eye image sample to acquire a reconstructed right-eye image.

S1730: A left-eye image is reconstructed according to the right-eye image sample and the disparity of the left-eye image sample.

In an optional embodiment of the present disclosure, a manner of reconstructing the left-eye image includes but not limited to: performing a re-projection on the right-eye image sample and the disparity map of the left-eye image sample, to acquire a reconstructed left-eye image.

S1740: A network parameter of the convolutional neural network is adjusted according to both a difference between the reconstructed left-eye image and the left-eye image sample and a difference between the reconstructed right-eye image and the right-eye image sample.

In an optional embodiment of the present disclosure, in a case of determining the differences, an adopted loss function includes but not limited to: L1 loss function, smooth loss function, lr-Consistency loss function, etc. In addition, in the present disclosure, in a case that the calculated loss is back propagated to adjust the network parameter of the convolutional neural network (such as a weight of a convolution kernel), the loss may be back propagated according to a gradient calculated based on chain derivation of the convolutional neural network, which helps to improve training efficiency of the convolutional neural network.

In an optional example of the present disclosure, in a case that the training for the convolutional neural network satisfies a predetermined iterative condition, training process ends. The predetermined iterative conditions in an embodiment of the present disclosure may include: a difference between the left-eye image reconstructed according to the disparity map output by the convolution neural network and the left-eye image sample, and a difference between the right-eye image reconstructed according to the disparity map output by the convolution neural network and the right-eye image sample, meet with the predetermined difference requirements. If the difference meets the requirements, the training of the convolutional neural network is successfully completed this time. The predetermined iterative conditions in the present disclosure may further include: the number of binocular image samples used for training the convolutional neural network reaches a predetermined number requirement, etc. In a case that the number of binocular image samples used for training the convolutional neural network meets the predetermined number requirement, the difference between the left-eye image reconstructed according to the disparity map output by the convolutional neural network and the left-eye image samples, and the difference between the right-eye image reconstructed according to the disparity map output by the convolutional neural network and the right-eye image samples do not meet the predetermined difference requirements, the training of the convolutional neural network is not successfully trained this time.

FIG. 18 illustrates a flowchart of a method of intelligent driving control according to an embodiment of the present disclosure. The method of intelligent driving control according to embodiments of the present disclosure may be applicable but not limited to an automatic driving (such as a completely unassisted automatic driving) environment or an assisted driving environment.

S1800: a video stream of the road where the vehicle is located is acquired through an image pickup device mounted on the vehicle. The image pickup device includes, but is not limited to, an RGB-based image pickup device.

S1810: moving object detection is performed on at least one video frame of the video stream to acquire a moving object involved in the video frame, for example, to acquire movement information of an object in the video frame in a three-dimensional space. For the specific implementation process of this step, please refer to the description of FIG. 1 in the foregoing method implementation, which is not elaborated here.

S1820: a vehicle control instruction is generated and output according to the moving object involved in the video frame. For example, the vehicle control instruction is generated according to the three-dimensional movement information of the object in the video frame and is output to control the vehicle.

In an optional embodiment of the present disclosure, the generated control instruction include but not limited to: a speed maintaining control instruction, a speed adjusting control instruction (such as for decelerating, or for accelerating, and etc.), a direction maintaining control instruction, a direction adjusting control instruction (such as for turning left, for turning right, for changing to the left lane, for changing to the right lane and etc.), a whistling instruction, a warn prompting control instruction or a driving mode switching control instruction (such as switching to automatic cruise driving mode, etc.).

It should be particularly noted that the moving object detection technology according to the present disclosure can be applied in the field of intelligent driving control, and can further be applied in other fields, for example, moving object detection in industrial manufacturing, moving object detection indoors such as supermarkets, and moving object detection in the security field, and etc. The present disclosure does not limit the application scenarios of moving object detection technology.

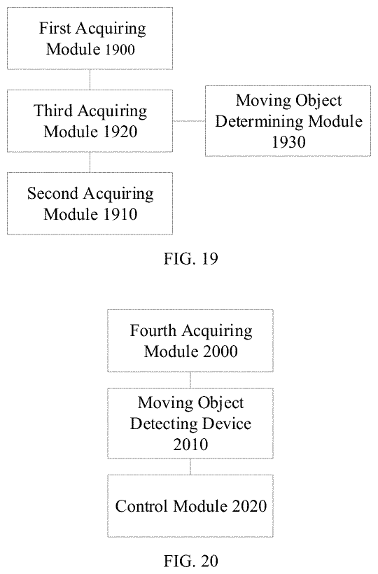

FIG. 19 illustrates a device for detecting moving object according to an embodiment of the present disclosure. The device illustrated in FIG. 19 includes: a first acquiring module 1900, a second acquiring module 1910, a third acquiring module 1920, and a moving object determining module 1930. In an optional embodiment of the present disclosure, the device may further include: a training module.

The first acquiring module 1900 is configured to acquire depth information of pixels of the image to be processed. In an optional embodiment of the present disclosure, the first acquiring module 1900 may include: a first sub-module and a second sub-module. The first sub-module is configured to acquire a first disparity map of the image to be processed. The second sub-module is configured to obtain the depth information of the pixels of the image to be processed according to the first disparity map of the image to be processed. In an optional embodiment of the present disclosure, the image to be processed includes: a monocular image. The first sub-module includes: a first unit, a second unit, and a third unit. The first unit is configured to input the image into be processed into a convolutional neural network, for a disparity analysis by the convolution neural network, to acquire the first disparity map of the image to be processed based on output of the convolutional neural network. The convolutional neural network is trained by a training module with binocular image samples. The second unit is configured to acquire a second horizontal mirror image of a second disparity map of a first horizontal mirror image of the image to be processed. The first horizontal mirror image of the image to be processed is a mirror image generated through performing a horizontal mirroring on the image to be processed. The second horizontal mirror image of the second disparity map is a mirror image generated through performing a horizontal mirroring on the second disparity map. The third unit is configured to adjust disparity of the first disparity map of the image to be processed according to a weight distribution map of the first disparity map of the image to be processed and a weight distribution map of the second horizontal mirror image of the second disparity map, to finally acquire the first disparity map of the image to be processed.

In an optional embodiment of the present disclosure, the second unit may input the first horizontal mirror image of the image to be processed into the convolutional neural network for a disparity analysis by the convolution neural network, to acquire a second disparity map of the first horizontal mirror image of the image to be processed based on output of the convolution neural network; the second unit performs mirroring on the second disparity map of the first horizontal mirror image of the image to be processed, to obtain a second horizontal mirror image of the second disparity map of the first horizontal mirror image of the image to be processed.

In an optional embodiment of the present disclosure, the weight distribution map includes at least one of: a first weight distribution map indicating a weight distribution map uniformly set for a plurality of images to be processed, and a second weight distribution map indicating a weight distribution map set individually for each of different images to be processed. The first weight distribution map includes at least two horizontally juxtaposed regions with different weight values.

In a case that the image to be processed is taken as a left-eye image, for any two regions in the first weight distribution map of the first disparity map of the image to be processed, a weight value of a right region is greater than a weight value of a left region, and for any two regions in the first weight distribution map of the second horizontal mirror image of the second disparity map, a weight value of a right region is greater than a weight value of a left region. For at least one region of the first weight distribution map of the first disparity map of the image to be processed, a weight value of the left part of the region is not greater than a weight value of the right part of the region; for at least one region of the first weight distribution map of the second horizontal mirror image of the second disparity map, a weight value of the left part of the region is not greater than a weight value of the right part of the region.

In a case that the image to be processed is taken as a right-eye image, for any two regions in the first weight distribution map of the first disparity map of the image to be processed, a weight value of a left region is greater than a weight value of a right region. For any two regions in the first weight distribution map of the second horizontal mirror image of the second disparity map, a weight value of the left region is greater than a weight value of the right region. For at least one region of the first weight distribution map of the first disparity map of the image to be processed, a weight value of the right part of the region is not greater than a weight value of the left part of the region; and for at least one region of the first weight distribution map of the second horizontal mirror image of the second disparity map, a weight value of the right part of the region is not greater than a weight value of the left part of the region.

In an optional embodiment of the present disclosure, the third unit is further configured to set a second weight distribution map of the first disparity map of the image to be processed. For example, the third unit performs horizontal mirroring on the first disparity map of the image to be processed to generate a mirror disparity map. For a pixel of the mirror disparity map, in a case that a disparity value of the pixel is greater than a first variable for the pixel, a weight value of the pixel for the second weight distribution map of the image to be processed is set to a first value, and otherwise, set to a second value; wherein the first value is greater than the second value. The first variable for the pixel is set according to both the disparity value of the pixel in the first disparity map of the image to be processed and a constant value greater than zero.

In an optional embodiment of the present disclosure, the third unit is further configured to set a second weight distribution map of the second horizontal mirror image of the second disparity map. For example, for a pixel of the second horizontal mirror image of the second disparity map, the third unit sets a weight value of the pixel for the second weight distribution map of the second horizontal mirror image of the second disparity map to a first value in a case that a disparity value of the pixel in the first disparity map of the image to be processed is greater than a second variable for the pixel, and to a second value otherwise; wherein the first value is greater than the second value. The second variable for the pixel is set according to both a disparity value of a corresponding pixel in the horizontal mirror image of the first disparity map of the image to be processed and a constant value greater than zero.

In an optional embodiment of the present disclosure, the third unit may be further configured to: firstly, adjust the disparity value of the first disparity map of the image to be processed according to both the first weight distribution map of the first disparity map of the image to be processed and the second weight distribution map of the first disparity map of the image to be processed; and next, the third unit adjusts a disparity value of the second horizontal mirror image of the second disparity map according to both the first weight distribution map of the second horizontal mirror image of the second disparity map and the second weight distribution map of the second horizontal mirror image of the second disparity map; and finally, the third unit combine the first disparity map that has been subject to disparity value adjustment and the second horizontal mirror image that has been subject to disparity value adjustment, to finally acquire the first disparity map of the image to be processed. For the operations performed by the first acquiring module 1900 and the sub-modules and the units thereof, reference may be made to the foregoing description of S100, which is not elaborated here.

The second acquiring module 1910 is configured to acquire optical flow information between the image to be processed and a reference image. The reference image and the image to be processed are two images that are collected by an image pickup device in a continuous photographing mode and have a timing sequence relationship. For example, the image to be processed is a video frame of a video collected by the image pickup device, and the reference image for the image to be processed includes: a preceding video frame of the video frame.

In an optional embodiment of the present disclosure, the second acquiring module 1910 may include: a third sub-module, a fourth sub-module, a fifth sub-module, and a sixth sub-module. The third sub-module is configured to acquire posture change of the image pickup device between capturing the image to be processed and capturing the reference image; the fourth sub-module is configured to establish a correspondence between pixel values of pixels in the image to be processed and pixel values of pixels in the reference image according to the posture change; the fifth sub-module is configured to convert the reference image according to the correspondence; the sixth sub-module is configured to calculate the optical flow information between the image to be processed and the reference image according to both the image to be processed and the converted reference image. The fourth sub-module may first acquire first coordinates of the pixels of the image to be processed within a three-dimensional coordinate system of the image pickup device corresponding to the image to be processed according to both the depth information and a preset parameter of the image pickup device; next, the fourth sub-module converts the first coordinates to a second coordinates within the three-dimensional coordinate system of the image pickup device corresponding to the reference image according to the posture change; and then, the fourth sub-module performs a projection on the second coordinates based on a two-dimensional coordinate system of the two-dimensional image to acquire projected two-dimensional coordinates of the image to be processed; and finally, the fourth sub-module establishes a correspondence between pixel values of pixels in the image to be processed and pixels values of pixels in the reference image according to both the projected two-dimensional coordinates of the image to be processed and two-dimensional coordinates of the reference image. For specific operations performed by the second acquiring module 1910 and by the sub-modules and the units of the second acquiring module, please refer to the foregoing description of S110, which is not elaborated here.

The third acquiring module 1920 is configured to acquire a three-dimensional motion field of the pixels of the image to be processed with respect to the reference image according to the depth information and the optical flow information. For the specific operations performed by the third acquiring module 1920, please refer to the above description of S120, which is not elaborated here.

The moving object determining module 1930 is configured to determine a moving object involved in the image to be processed according to the three-dimensional motion field. In an optional embodiment of the present disclosure, the moving object determining module may include: a seventh sub-module, an eighth sub-module, and a ninth sub-module. The seventh sub-module is configured to acquire movement information of the pixels in the image to be processed in a three-dimensional space according to the three-dimensional motion field. For example, the seventh sub-module can calculate speeds of the pixels in the image to be processed in the three coordinate axis directions of the three-dimensional coordinate system of the image pickup device corresponding to the image to be processed according to both the three-dimensional motion field and the time difference between capturing the image to be processed and capturing the reference image. The eighth sub-module is configured to perform a clustering on the pixels according to their three-dimensional movement information. For example, the eighth sub-module includes: a fourth unit, a fifth unit, and a sixth unit. The fourth unit is configured to acquire a motion mask of the image to be processed according to the three-dimensional movement information of the pixels. The three-dimensional movement information of the pixels includes three-dimensional speeds magnitudes of the pixels. The fourth unit can filter the speeds magnitudes of the pixels in the image to be processed with a preset speed threshold to generate the motion mask of the image to be processed. The fifth unit is configured to determine the motion region in the image to be processed according to the motion mask. The sixth unit is configured to perform a clustering on the pixels in the motion region according to the three-dimensional spatial position and the movement information of the pixels in the motion region. For example, the sixth unit can convert the three-dimensional coordinates of the pixels in the motion region into a predetermined coordinate interval; and then, the sixth unit converts the speeds of the pixels of the motion region into a predetermined speed interval; and finally, the sixth unit performs a density clustering on the pixels of the motion region according to the converted three-dimensional spatial coordinates and the converted speeds of the pixels of the motion region, to obtain at least one class cluster. The ninth sub-module is configured to determine a moving object involved in the image to be processed according to the result of the clustering. For example, for any class cluster, the ninth sub-module may determine the speed magnitude and the speed direction of the moving object according to the speed magnitudes and the speed directions of a plurality of pixels of the class cluster; wherein, a class cluster is taken as a moving object involved in the image to be processed. The ninth sub-module is further configured to determine a moving object bounding box in the image to be processed according to the spatial position of pixels belonging to a same class cluster. For the specific operations performed by the moving object determining module 1930 and by its sub-modules and its units, reference may be made to the foregoing description of S130, which is not elaborated here.

The training module is configured to input a plurality of monocular images of the binocular image samples into a convolutional neural network to be trained, for performing a disparity analysis by the convolutional neural network. Based on output of the convolutional neural network, the training module acquires a disparity map of a left-eye image sample and a disparity map of a right-eye image. The training module reconstructs a right-eye image according to both the left-eye image sample and the disparity map of the right-eye image sample, and reconstructs a left-eye image according to both the right-eye image sample and the disparity map of the left-eye image sample. And the training module adjusts network parameter of the convolution neural network according to both a difference between the reconstructed left-eye image and the left-eye image sample and a difference between the reconstructed right-eye image and the right-eye image sample. Specific operations performed by the training module may be referred to the above description with respect to FIG. 17, which will not be elaborated here.

A device for intelligent driving control according to the present disclosure is illustrated in FIG. 20. The device illustrated in FIG. 20 includes: a fourth acquiring module 2000, a moving object detecting device 2010, and a control module 2020. The fourth acquiring module 2000 is configured to acquire a video stream of a road on which the vehicle is located through an image pickup device mounted on the vehicle. The moving object detecting device 2010 is configured to perform moving object detection on at least one video frame of the video stream, to determine a moving object involved in the video frame. The structure of the moving object detecting device 2010 and the specific operations performed by respective module, respective sub-module, and respective unit may be referred to the description of FIG. 19, which will not be elaborated here. The control module 2020 is configured to generate and output a control instruction for the vehicle according to the moving object. The control instructions generated and output by the control module 2020 include, but not limited to: a speed maintaining control instruction, a speed adjusting control instruction, a direction maintaining control instruction, a direction adjusting control instruction, a warn prompting control instruction, and a driving mode switching control instruction.

Exemplary Apparatus

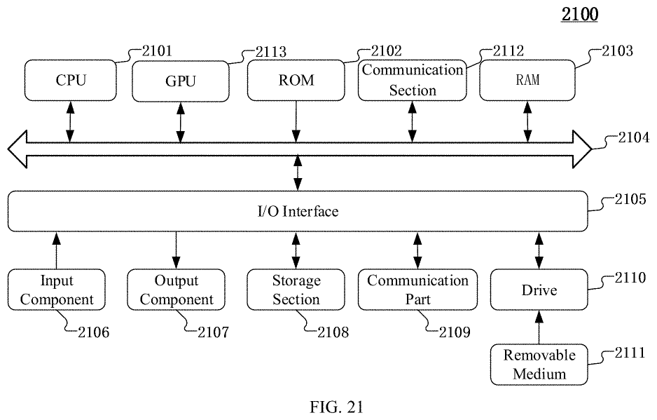

FIG. 21 illustrates an exemplary apparatus 2100 suitable to implement the present disclosure. The apparatus 2100 may be a control system/electronic system provided on a car, a mobile terminal (for example, a smart mobile phone, etc.), a personal computer (PC, for example, a desktop computer or a laptop computer, etc.), a tablet, a server, etc. In FIG. 21, the apparatus 2100 includes one or more processors, communication section, etc., the one or more processors may be: one or more central processing units (CPU) 2101, and/or, one or more graph processing units (GPU) 2113 which performs visual tracking by means of a neural network, etc. The one or more processor may perform various appropriate actions and processing based on executable instructions stored in read only memory (ROM) 2102 or loaded from a storage section 2108 to random access memory (RAM) 2103. The communication section 2112 may include but not limited to a network card, and the network card may include but not limited to an IB (Infiniband) network card. The processor may be communicated with the read-only memory 2102 and/or the random access memory 2103 to execute the executable instructions, may be connected to the communication section 2112 via a bus 2104, and may be communicated with other target devices via the communication section 2112, thereby completing the corresponding steps of the present disclosure.

For the operations implemented by the foregoing instructions, reference may be made to the related descriptions in the foregoing method embodiments, and detailed descriptions are omitted here. In addition, the RAM 2103 may further store various programs and data required for the operation of the apparatus. The CPU 2101, the ROM 2102, and the RAM 2103 are connected to each other via the bus 2104.

In the case of RAM2103, ROM2102 is optional. The RAM 2103 stores executable instructions, or writes executable instructions into the ROM 2102 during operation, and the executable instructions cause the CPU 2101 to implement operations of the above-mentioned method of detecting moving object or the method of intelligent driving control. An input/output (I/O) interface 2105 is also connected to the bus 2104. The communication section 2112 may be integrated or may be configured to have a plurality of sub-modules (for example, a plurality of IB network cards), each of which are connected to the bus respectively.

The following components are connected to the I/O interface 2105: an input component 2106 such as a keyboard, a mouse, etc.; an output component 2107 such as a cathode ray tube (CRT), a liquid crystal display (LCD), or the like, and speakers, and etc.; a storage section 2108 including a hard disk, and the like, and a communication section 2109 including a network interface card such as a LAN card, a modem, etc. The communication section 2109 performs communication via a network such as the Internet. A driver 2110 is further connected to the I/O interface 2105 as needed. A removable medium 2111, such as a magnetic disk, an optical disk, a magneto-optical disk, a semiconductor memory, etc., is installed on the drive 2110 as needed, so that the computer program read therefrom is installed in the storage portion 2108 as needed.

It should be noted that the architecture illustrated in FIG. 21 is just an optional implementation. In practice implementation, the number and types of components as illustrated in FIG. 21 can be selected, deleted, added, or replaced according to actual needs. As to the configuration of various functional components, they may be integrated or provided separately. For example, the GPU2113 and the CPU2101 may be provided separately. For another example, the GPU2113 may be integrated in the CPU2101, and the communication section may be provided separately or be integrated in the CPU2101 or GPU2113, etc. These alternative embodiments all fall into the protection scope of the present disclosure.

In particular, according to the embodiments of the present disclosure, the process described above with reference to the flowcharts can be implemented as a computer software program. For example, the embodiments of the present disclosure involve a computer program product, which includes a computer program product tangibly contained on a machine-readable medium. The computer program includes program codes for implementing the operations of the method as illustrated in the flowchart. The program codes may include instructions corresponding to the steps of the method according to the present disclosure.

In such embodiments, the computer program may be downloaded from the network through the communication part 2109 and installed, and/or installed from the removable medium 2111. When the computer program is executed by the CPU 2101, the instructions described in the present disclosure to implement the above-mentioned corresponding steps are executed.

In one or more optional implementation manners, embodiments of the present disclosure further provide a computer program product for storing computer-readable instructions, which, upon being executed, cause a computer to implement operations of the method of detecting moving object or operations of the method of intelligent driving control method according to any embodiment of the present disclosure. The computer program product can be specifically implemented by hardware, software or a combination thereof. In an optional example, the computer program product may be embodied as a computer storage medium. In another optional example, the computer program product may be embodied as a software product, such as a software development kit (SDK), etc.

In one or more optional implementation manners, the embodiments of the present disclosure further provide another method of detecting moving object or another method of intelligent driving control and corresponding devices and electronic apparatus, computer storage media, computer programs, and computer program products. The method includes: transmitting, by a first device and to a second device, an instruction to detect moving object or to drive intelligently, the instruction causes the second device to implement operations of the method of moving object detection according to any one of the possible embodiments of the present disclosure or the method of intelligent driving control according to any one of the possible embodiments of the present disclosure; and receiving, by the first device and from the second device, a result of moving object detection or a result or intelligent driving control.

In some embodiments, the instruction to detect moving object or the instruction to drive intelligently may be a calling instruction, and the first device may instruct the second device to perform moving object detection or intelligent driving control by calling, and correspondingly, in response to the calling instruction, the second device may implement the steps and/or processes of the method of detecting moving object according to any one of the possible embodiments of the present disclosure or of the method of intelligent driving control according to any one of the possible embodiments of the present disclosure.

It should be understood that terms such as “first” and “second” in the embodiments of the present disclosure are only for distinguishing purposes, and should not be construed as a limit to the embodiments of the present disclosure. It should also be understood that in the present disclosure, the term “plural” may refer to two or more, and the term “at least one” can refer to one, two, or more than two. It should also be understood that any component, data, or structure mentioned in the present disclosure can typically be understood as one or more unless it is clearly defined or the context gives opposite enlightenment. It should also be understood that the description of the various embodiments of the present disclosure focuses the differences between the various embodiments, and the same or similarities can be referred to each other, and for the sake of brevity, the details are not elaborated.

The method and apparatus, electronic apparatus, and computer-readable storage medium of the present disclosure may be implemented in many ways. For example, the method and device, electronic apparatus, and computer-readable storage medium of the present disclosure can be implemented by software, hardware, firmware or any combination of software, hardware, and firmware. The above-mentioned sequence of the steps of the method is just illustrative, and the steps of the method of the present disclosure are not limited to the sequence specifically described above, unless otherwise specified. In addition, in some embodiments, the present disclosure can further be implemented as programs recorded in a recording medium, and these programs include machine-readable instructions for implementing operations of the method according to the present disclosure. Thus, the present disclosure further covers a recording medium storing a program for executing the method according to the present disclosure.

The description of the present disclosure is given for the sake of illustration and description, rather than being exhaustive or limiting the present disclosure to the disclosed form. Many modifications and variants are obvious to those of ordinary skill in the art. The selection and description of the embodiments are to better explain the principles and practical applications of the present disclosure, and to enable those of ordinary skill in the art to understand that the embodiments of the present disclosure can design various implementations with various modifications suitable for specific purposes.

What is claimed is:

1. A method of detecting moving object, comprising:
acquiring depth information of pixels of an image to be processed;
acquiring optical flow information between the image to be processed and a reference image, wherein the reference image and the image to be processed are two images that are collected by an image pickup device in a continuous photographing mode and have a timing sequence relationship;
acquiring, according to both the depth information and the optical flow information, a three-dimensional motion field of the pixels of the image to be processed with respect to the reference image; and
determining a moving object involved in the image to be processed according to the three-dimensional motion field.

2. The method according to claim 1, wherein acquiring the depth information of the pixels of the image to be processed comprises:
acquiring a first disparity map of the image to be processed; and
acquiring the depth information of the pixels of the image to be processed according to the first disparity map.

3. The method according to claim 2, wherein
the image to be processed comprises a monocular image, and
acquiring the first disparity map of the image to be processed comprises:
inputting the image to be processed into a convolutional neural network for performing a disparity analysis by the convolutional neural network based on output of the convolution neural network;
acquiring a second horizontal mirror image of a second disparity map of a first horizontal mirror image of the image to be processed, wherein the first horizontal mirror image of the image to be processed is a mirror image generated by performing a horizontal mirroring on the image to be processed, and the second horizontal mirror image of the second disparity map is a mirror image generated by performing a horizontal mirroring on the second disparity map; and
performing a disparity adjustment on the first disparity map according to both a weight distribution map of the first disparity map and a weight distribution map of the second horizontal mirror image, to finally acquire the first disparity map of the image to be processed;
wherein the convolutional neural network is trained with binocular image samples.

4. The method according to claim 3, wherein acquiring the second horizontal mirror image of the second disparity map of the first horizontal mirror image of the image to be processed comprises:
inputting the first horizontal mirror image of the image to be processed into the convolutional neural network for performing a disparity analysis by the convolutional neural network, to acquire the second disparity map of the first horizontal mirror image of the image to be processed based on output of the convolutional neural network; and
performing a mirroring on the second disparity map to acquire the second horizontal mirror image.

5. The method according to claim 3, wherein the weight distribution map comprises at least one of:
a first weight distribution map indicating a weight distribution map uniformly set for a plurality of images to be processed; and
a second weight distribution map indicating a weight distribution map set individually for each of different images to be processed;
wherein the first weight distribution map comprises at least two horizontally juxtaposed regions with different weight values.

6. The method according to claim 5, wherein,
in a case that the image to be processed is a left-eye image,
for any two regions in the first weight distribution map of the first disparity map, a weight value of a right region is greater than a weight value of a left region;
for any two regions in the first weight distribution map of the second horizontal mirror image, a weight value of a right region is greater than a weight value of a left region;
for at least one region of the first weight distribution map of the first disparity map, a weight value of a left part of the region is not greater than a weight value of a right part of the region; and
for at least one region of the first weight distribution map of the second horizontal mirror image, a weight value of a left part of the region is not greater than a weight value of a right part of the region; and
in a case that the image to be processed is a right-eye image:
for any two regions in the first weight distribution map of the first disparity map, a weight value of a left region is greater than a weight value of a right region;
for any two regions in the first weight distribution map of the second horizontal mirror image, a weight value of a left region is greater than a weight value of a right region;
for at least one region of the first weight distribution map of the first disparity map, a weight value of a right part of the region is not greater than a weight value of a left part of the region; and
for at least one region of the first weight distribution map of the second horizontal mirror image, a weight value of a right part of the region is not greater than a weight value of a left part of the region.

7. The method according to claim 6, wherein setting the second weight distribution map of the first disparity map comprises:
performing a horizontal mirroring on the first disparity map to generate a mirror disparity map; and
for a pixel of the mirror disparity map,
in a case that a disparity value of the pixel is greater than a first variable for the pixel, setting a weight value of the pixel for the second weight distribution map of the first disparity map to a first value, and
in a case that the disparity value of the pixel is less than or equal to the first variable for the pixel, setting the weight value of the pixel for the second weight distribution map of the first disparity map to a second value;
wherein the first value is greater than the second value, and the first variable for the pixel is set according to both the disparity value of the pixel in the first disparity map and a constant value greater than zero.

8. The method according to claim 7, wherein setting the second weight distribution map of the second horizontal mirror image comprises:
for a pixel of the second horizontal mirror image,
in a case that a disparity value of the pixel in the first disparity map is greater than a second variable for the pixel, setting a weight value of the pixel for the second weight distribution map of the second horizontal mirror image to a first value; and
in a case that the disparity value of the pixel in the first disparity map is less than or equal to the second variable for the pixel, setting the weight value of the pixel for the second weight distribution map of the second horizontal mirror image to a second value;
wherein the first value is greater than the second value, and the second variable for the pixel is set according to both a disparity value of a corresponding pixel in the horizontal mirror image of the first disparity map and a constant value greater than zero.

9. The method according to claim 7, wherein performing a disparity adjustment on the first disparity map according to both the weight distribution map of the first disparity map and the weight distribution map of the second horizontal mirror image, comprises:
adjusting a disparity value of the first disparity map according to both the first weight distribution map and the second weight distribution map of the first disparity map;
adjusting a disparity value of the second horizontal mirror image according to both the first weight distribution map and the second weight distribution map of the second horizontal mirror image; and
combining the first disparity map with adjusted disparity value and the second horizontal mirror image with adjusted disparity value to finally acquire the first disparity map of the image to be processed.

10. The method according to claim 1, wherein acquiring the optical flow information between the image to be processed and the reference image comprises:
acquiring posture change information between capturing the image to be processed and capturing the reference image by the image pickup device;
establishing a correspondence between pixel values of pixels in the image to be processed and pixel values of pixels in the reference image according to the posture change information;
performing a conversion on the reference image according to the correspondence; and
determining the optical flow information between the image to be processed and the reference image according to both the image to be processed and the converted reference image.

11. The method according to claim 10, wherein establishing the correspondence between the pixel values of pixels in the image to be processed and the pixel values of pixels in the reference image according to the posture change information comprises:
acquiring, according to the depth information and a preset parameter of the image pickup device, first coordinates of pixels in the image to be processed within a three-dimensional coordinate system of the image pickup device corresponding to the image to be processed;
converting the first coordinates to second coordinates within a three-dimensional coordinate system of the image pickup device corresponding to the reference image according to the posture change information;
acquiring a projected two-dimensional coordinates of the image to be processed by projecting the second coordinates onto a two-dimensional coordinate system of a two-dimensional image; and
establishing a correspondence between pixel values of pixels in the image to be processed and pixel values of pixels in the reference image according to both the projected two-dimensional coordinates of the image to be processed and a two-dimensional coordinates of the reference image.

12. The method according to claim 1, wherein determining the moving object involved in the image to be processed according to the three-dimensional motion field comprises:
acquiring three-dimensional movement information of pixels in the image to be processed according to the three-dimensional motion field;
performing a clustering on the pixels according to the three-dimensional movement information of the pixels; and
determining a moving object involved in the image to be processed according to a result of the clustering.

13. The method according to claim 12, wherein acquiring three-dimensional movement information of pixels in the image to be processed according to the three-dimensional motion field comprises:
calculating speeds of pixels of the image to be processed in the three coordinate axis directions of the three-dimensional coordinate system of the image pickup device corresponding to the image to be processed according to both the three-dimensional motion field and a time difference between capturing the image to be processed and capturing the reference image.

14. The method according to 12, wherein
the three-dimensional movement information of the pixels comprises: speed magnitudes of the pixels, and
performing the clustering on the pixels according to the three-dimensional movement information of the pixels comprises:
filtering the speed magnitudes of the pixels in the image to be processed with a preset speed threshold to generate a motion mask of the image to be processed;
determining a motion region in the image to be processed according to the motion mask; and
performing a clustering on pixels in the motion region according to both three-dimensional space positions and three-dimensional movement information of the pixels in the motion region.

15. The method according to claim 14, wherein
performing the clustering on the pixels in the motion region according to both the three-dimensional spatial position and the three-dimensional movement information of pixels in the motion region comprises:
converting three-dimensional coordinates of pixels in the motion region into a predetermined coordinate interval;
converting the speeds of the pixels in the motion region into a predetermined speed interval; and
performing a density clustering on the pixels in the motion region according to the converted three-dimensional coordinates and the converted speeds, to acquire at least one cluster; and
determining the moving object involved in the image to be processed according to the result of the clustering comprises:
determining, for a class cluster of at least one class cluster, a speed magnitude and a speed direction of a moving object according to speed magnitudes and speed directions of a plurality of pixels of the class cluster;
wherein the class cluster is the moving object involved in the image to be processed.

16. The method according to claim 12, wherein determining the moving object involved in the image to be processed according to the result of the clustering further comprises:
determining a moving object bounding box in the image to be processed according to spatial position information of pixels of a same class cluster.

17. A method of intelligent driving control, comprising:
acquiring, by an image pickup device mounted on a vehicle, a video stream of a road where the vehicle is located;
performing a moving object detection on at least one video frame of the video stream through the method according to claim 1, to determine a moving object involved in the at least one video frame; and
generating and outputting a control instruction for the vehicle according to the moving object.

18. An electronic apparatus, comprising:
memory, configured to store computer readable program; and
a processor, configured to execute the computer readable program stored in the memory, wherein when the computer readable program is executed, the processor is configured to:
acquire depth information of pixels of an image to be processed;
acquire optical flow information between the image to be processed and a reference image, wherein the reference image and the image to be processed are two images that are collected by an image pickup device in a continuous photographing mode and have a timing sequence relationship;
acquire, according to both the depth information and the optical flow information, a three-dimensional motion field of the pixels of the image to be processed with respect to the reference image; and
determine a moving object involved in the image to be processed according to the three-dimensional motion field.

19. A non-transitory computer-readable storage medium on which a computer readable program is stored, wherein when the computer readable program is executed by a processor, the processor is configured to:
acquire depth information of pixels of an image to be processed;
acquire optical flow information between the image to be processed and a reference image, wherein the reference image and the image to be processed are two images that are collected by an image pickup device in a continuous photographing mode and have a timing sequence relationship;
acquire, according to both the depth information and the optical flow information, a three-dimensional motion field of the pixels of the image to be processed with respect to the reference image; and
determine a moving object involved in the image to be processed according to the three-dimensional motion field.

20. An electronic apparatus for intelligent driving control, comprising: memory, configured to store computer readable program; and
a processor, configured to execute the computer readable program stored in the memory, wherein when the computer readable program is executed, the processor is configured to:
acquire, by an image pickup device mounted on a vehicle, a video stream of a road where the vehicle is located;
perform a moving object detection on at least one video frame of the video stream by the electronic apparatus according to claim 18, to determine a moving object involved in the at least one video frame; and
generate and output a control instruction for the vehicle according to the moving object.
